(19) United States
(12) Patent Application Publication
(10) Pub. No.: US 2026/0288803 A1
(43) Pub. Date: Sep. 24, 2026

(54) SYSTEM

(71) Applicant: SoftBank Group Corp., Tokyo (JP)

(72) Inventor: Gaku KOBAYASHI, Tokyo (JP)

(73) Assignee: SoftBank Group Corp., Tokyo (JP)

(21) Appl. No.: 19/565,515

(22) Filed: Mar. 13, 2026

(30) Foreign Application Priority Data
Mar. 19, 2025 (JP) 2025-044925

(51) Int. Cl. G06F 16/3329; G06F 16/901; G06F 40/284; G06F 40/295; G06N 3/048; G06N 3/0499; G06Q 10/0631

(52) U.S. Cl. CPC G06F 16/33295; G06F 16/9024; G06F 40/284; G06F 40/295; G06N 3/048; G06N 3/0499; G06Q 10/063118

(57) ABSTRACT

A system includes a processor that is configured to: collect information and perform preprocessing on the collected information; analyze the preprocessed information by using a large language model to identify relationships and areas of expertise represented in the information; and generate and input a prompt to a generative artificial intelligence model so as to instruct the generative artificial intelligence model to obtain specific information.

### CROSS-REFERENCE TO RELATED APPLICATION

This application is based on and claims priority under 35 USC 119 from Japanese Patent Application No. 2025-044925 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information management and expert search systems have difficulty effectively utilizing large volumes of heterogeneous information, such as employee profiles, communication logs, documents, and other digital artifacts, to accurately identify relationships among entities and areas of expertise. In many organizations, collected information is fragmented across multiple systems and is not preprocessed or structured in a manner suitable for advanced analysis by large language models. As a result, it is difficult to automatically determine which person, document, or resource is most relevant to a given inquiry, and users must manually search and interpret dispersed information. Furthermore, conventional systems do not adequately generate prompts for generative artificial intelligence models in a way that reliably obtains specific information tailored to the user's needs, thereby limiting the precision and usefulness of responses based on such models. Accordingly, there is a need for a system that can systematically collect and preprocess information, analyze the information using a large language model to identify relationships and areas of expertise, and generate and input prompts to a generative artificial intelligence model so as to instruct the generative artificial intelligence model to obtain specific information, thereby enabling accurate and efficient provision of relevant information and identification of persons having specific expertise.

### SUMMARY

In order to solve the above-described problems, an aspect of the invention provides a system comprising a processor, wherein the processor is configured to collect information and perform preprocessing on the collected information, analyze the preprocessed information by using a large language model to identify relationships and areas of expertise represented in the information, and generate and input a prompt to a generative artificial intelligence model so as to instruct the generative artificial intelligence model to obtain specific information. In one embodiment, the processor is configured to provide appropriate information in response to an inquiry on the basis of an analysis result obtained by the large language model, thereby enabling a user to receive information that is contextually relevant to the user's question. In another embodiment, the processor is configured to identify a person having a specific area of expertise on the basis of an analysis result obtained by the large language model, thereby supporting expert discovery and recommendation within an organization. By integrating preprocessing, large language model based analysis, and prompt generation for a generative artificial intelligence model within a single system, the invention enables automated, accurate, and efficient retrieval of specific information and identification of experts corresponding to various inquiries.

The term “system” refers to an integrated combination of hardware, software, and communication components that cooperatively execute processing operations to implement the functions described in the claims.

The term “processor” refers to one or more hardware processing units, such as a central processing unit (CPU), a graphics processing unit (GPU), or a dedicated accelerator, and may further encompass a combination of such units operating under control of software to perform computational operations.
The term “information” refers to data of any type, including but not limited to text data, numerical data, structured records, semi-structured data, and unstructured data, which is subject to collection, preprocessing, and analysis by the processor.
The term “collect” refers to acquiring information from one or more sources, such as databases, file systems, communication logs, sensor outputs, or external services, and storing the acquired information within the system for subsequent processing.
The term “preprocessing” refers to one or more operations performed on collected information prior to main analysis, including, for example, cleaning, normalizing, tokenizing, segmenting, filtering, transforming formats, or otherwise preparing the information for processing by a large language model.
The term “large language model” refers to a machine learning model trained on a large corpus of text data and configured to perform natural language understanding or generation tasks, including, for example, identifying entities, relationships, or topics within text.
The term “analyze” refers to processing information using algorithmic or statistical methods, including the application of a large language model, in order to derive structured results such as detected relationships, classifications, topics, or areas of expertise.
The term “relationships” refers to associations identified between entities represented in the information, such as associations between persons, documents, topics, skills, or other items, including but not limited to collaborative relationships, topical relationships, or hierarchical relationships.
The term “areas of expertise” refers to domains, topics, skills, or fields in which a person or entity possesses knowledge, experience, or proficiency, as inferred or identified from analyzed information.
The term “generative artificial intelligence model” refers to a machine learning model configured to generate output data, such as natural language text, in response to input data, and includes but is not limited to generative large language models.
The term “prompt” refers to data supplied to a generative artificial intelligence model as input, including instructions, questions, or context information, that conditions or guides the output generated by the model.
The term “generate and input a prompt” refers to creating a prompt by programmatically constructing or composing input data based on analysis results or other information, and then supplying the created prompt to a generative artificial intelligence model for processing.
The term “specific information” refers to information that satisfies one or more conditions or requirements determined by the system, such as relevance to an inquiry, relevance to a particular relationship or area of expertise, or inclusion of particular types of content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

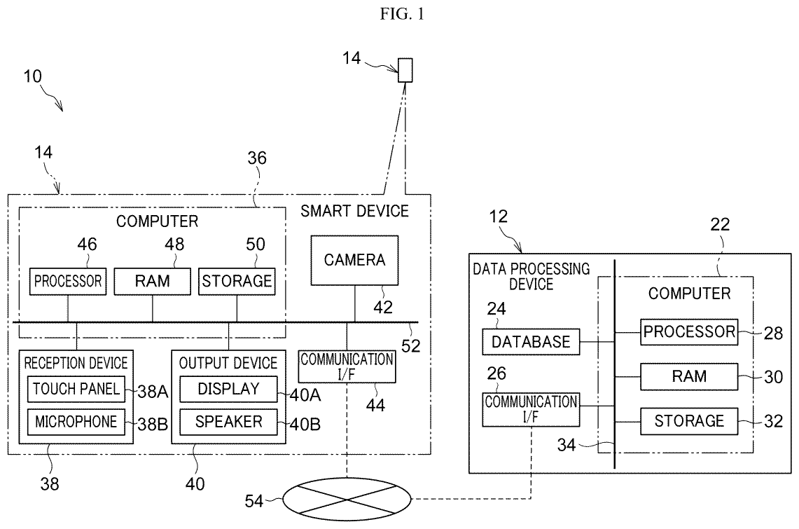

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

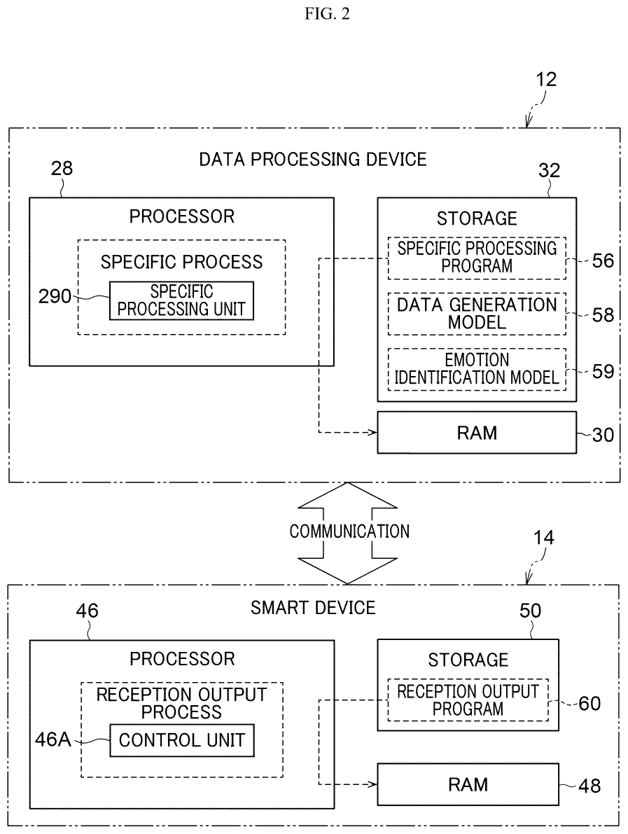

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that attempt to identify human expertise and relationships within an organization typically rely on static profile data, manually maintained skill tags, or simple keyword searches over communication logs and deliverables. Such systems suffer from several technical limitations in terms of computer technology.

First, when large volumes of heterogeneous text data are ingested from multiple information sources such as communication systems, document repositories, and business applications, conventional systems often apply ad hoc or application-specific preprocessing. As a result, text encoding, notation, and formatting inconsistencies remain unresolved, and downstream natural language processing components must repeatedly handle noisy and redundant data. This leads to increased computational load, inefficient memory usage, and degraded accuracy of machine inference.
Second, when large-scale language models and generative AI models are used as back-end components, conventional systems typically submit raw or loosely structured prompts, allowing the models to both interpret the user's question and access or infer domain facts in a single step. In such architectures, the model is not constrained to operate strictly on verifiable structured data stored in the system. This causes several technical problems: (i) the model may generate answers that are not grounded in the stored data, (ii) the system must repeatedly send large amounts of context text, increasing latency, computational cost, and network traffic, and (iii) it becomes difficult to validate or cache intermediate results, resulting in inefficient utilization of computing resources.
Third, many existing systems do not construct or maintain an explicit, searchable relationship structure that represents correspondences among persons, skills, and relationships as structured data. Without such a relationship structure, every query requires recomputing inferences directly from unstructured text or from opaque model outputs. This results in repetitive processing by the language model, poor scalability as the volume of data grows, and limited ability to optimize database indexing and graph traversal operations.
Fourth, conventional systems that allow users to submit natural language queries to a generative AI model generally do not separate (a) the generation of a machine-readable intermediate representation for query planning from (b) the generation of a natural language answer. Consequently, the system cannot efficiently verify that the generative AI model's answer corresponds to authoritative structured data; nor can it systematically limit the candidates of persons, skills, and relationships to those represented in the stored knowledge. This lack of a verifiable intermediate representation leads to technical issues such as difficulty enforcing data access policies, inability to detect model hallucinations, and increased need for manual post-processing.
Accordingly, there is a need for an improved computer-implemented system that (i) normalizes and structures heterogeneous text data into analysis-ready units optimized for large-scale language model input constraints, (ii) uses a large-scale language model to derive structured representations of expertise and relationships that are stored and indexed as a relationship structure, and (iii) uses a generative AI model in a constrained manner, via intermediate representations and structured queries, to generate natural language answers that are verifiably grounded in stored structured data. Such a system should improve computational efficiency, scalability, reliability of generated answers, and the technical behavior of the overall information processing pipeline on the server side.

The specific processing by the specific processing unit 290 of the data processing device 12 in Example 1 is realized by the following means.

The present invention provides a server comprising a processor configured to acquire, from a plurality of information sources, attribute information, communication history information, and deliverable information regarding persons, integrate the acquired information, and store the integrated information as recorded information; extract character data from the recorded information, normalize an encoding format, a notation format, and a layout of the character data, remove unnecessary portions from the character data, and generate analysis target data to be input to a large-scale language model; divide the analysis target data into units and generate analysis data sets grouped on a person basis or a topic basis while controlling a token count or a character count in accordance with an input constraint of the large-scale language model; input the analysis data sets into the large-scale language model, obtain analysis results including expertise information of the persons and relationship information between the persons from the large-scale language model, and store the analysis results as structured data; generate a relationship structure indicating correspondences among the persons, skills, and relationships on the basis of the structured data, and hold the relationship structure as a searchable knowledge representation; receive a prompt sentence in a natural language input by a user, cause a generative AI model to generate an intermediate representation for converting the prompt sentence into a structured query including a search condition for the relationship structure, perform a search process on the relationship structure on the basis of the intermediate representation obtained from the generative AI model, and generate a prompt sentence to input response data including the structured data obtained as a result of the search process into the generative AI model and obtain an answer sentence in the natural language from the generative AI model. This enables the server to transform heterogeneous organizational text data into normalized analysis units tailored to large-scale language model constraints, to persistently maintain a searchable relationship structure that supports efficient database and graph queries, and to use generative AI models in a constrained, verifiable manner via intermediate representations so that natural language answers are grounded in stored structured data, thereby improving computational efficiency, scalability, and reliability of the overall computer-implemented information processing.

The term “processor” refers to a hardware or virtual processing unit, such as a central processing unit or a virtual machine instance, that executes instructions to perform the functions described in the present disclosure.

The term “information source” refers to any hardware or software system that provides data regarding persons, including but not limited to communication systems, storage systems, and business applications.
The term “attribute information” refers to structured or semi-structured data describing characteristics of persons, such as roles, organizational affiliations, skills, and project-related attributes.
The term “communication history information” refers to data representing past exchanges between persons via electronic communication systems, including message contents, participants, timestamps, and related metadata.
The term “deliverable information” refers to data representing work products associated with persons, such as documents, presentations, reports, and other output artifacts stored in electronic form.
The term “recorded information” refers to integrated data obtained by aggregating attribute information, communication history information, and deliverable information and storing the aggregated data in a storage device.
The term “character data” refers to textual content extracted from recorded information, including sequences of characters, symbols, or encoded text segments that are processable by text processing components.
The term “encoding format” refers to a representation scheme for character data, such as a character encoding or code set, used to store, transmit, or process text.
The term “notation format” refers to conventions used in character data, such as spellings, abbreviations, numeral formats, date formats, and other representational styles of textual expressions.
The term “layout” refers to structural or presentational aspects of character data, including line breaks, indentation, headings, and other formatting-related elements.
The term “unnecessary portions” refers to parts of character data that are considered irrelevant or redundant for analysis by a language model, such as boilerplate disclaimers, signatures, or system-generated headers.
The term “analysis target data” refers to normalized and cleaned units of character data prepared to be input to a large-scale language model for analysis.
The term “large-scale language model” refers to a machine learning model trained on a large corpus of text data and configured to process natural language input, such as a neural network-based language model with parameters in a high order of magnitude.
The term “unit” refers to a segment of analysis target data that is treated as a single processing block, such as a group of sentences, a document portion, or a topic-focused text segment.
The term “token count” refers to the number of discrete subword units or symbols into which character data is segmented for processing by a language model.
The term “character count” refers to the number of characters contained in character data, independently of any tokenization used by a language model.
The term “input constraint” refers to a limitation imposed by a language model on the maximum size of input data, such as a maximum number of tokens or characters.
The term “analysis data set” refers to a collection of one or more units of analysis target data, grouped according to a predetermined criterion, to be input to a large-scale language model in a single analysis operation.
The term “person basis” refers to grouping analysis target data according to identifiers of persons, so that data related to the same person is processed together.
The term “topic basis” refers to grouping analysis target data according to content-related criteria, such as shared themes, project names, or subject keywords.
The term “analysis result” refers to output information generated by a large-scale language model in response to analysis data sets, including inferred properties, classifications, and relationships.
The term “expertise information” refers to information derived from analysis results indicating knowledge areas, skills, or domains of proficiency associated with persons.
The term “relationship information” refers to information derived from analysis results indicating associations between persons, such as collaboration, co-participation in projects, or shared topics.
The term “structured data” refers to data stored in a format with an explicit schema, such as records, fields, or key-value pairs, which is suitable for indexing, querying, and validation.
The term “relationship structure” refers to a data structure representing correspondences among persons, skills, and relationships, such as a graph structure, table structure, or combined representation supporting linkage between entities.
The term “skill” refers to a capability, expertise area, or technical proficiency associated with a person, as represented in structured data.
The term “searchable knowledge representation” refers to a form of relationship structure stored in a system such that it can be queried by search operations using conditions on entities and relationships.
The term “prompt sentence” refers to a natural language input provided by a user, intended to instruct a model or system to perform a specific information retrieval or processing task.
The term “user” refers to an operator or entity that interacts with the system by submitting prompt sentences or receiving results via an interface.
The term “generative AI model” refers to an artificial intelligence model configured to generate output data, including natural language text or structured representations, in response to input data or instructions.
The term “intermediate representation” refers to a machine-readable representation derived from a prompt sentence, which encodes a query intent or search condition in a structured format suitable for computational processing.
The term “structured query” refers to a query expressed in a formal description language or predefined schema, specifying conditions and constraints to be applied to the relationship structure.
The term “search condition” refers to a constraint or criterion used to filter or select elements within the relationship structure during a search process.
The term “search process” refers to a computational operation that applies a structured query with search conditions to the relationship structure to retrieve matching structured data.
The term “response data” refers to structured data retrieved as a result of the search process and prepared for further processing or answer generation.
The term “answer sentence” refers to a natural language output generated by a generative AI model based on response data and intended to be presented to a user as an answer.

In one embodiment, a server, a terminal, and a user cooperate to implement the claimed system. The server includes at least one hardware processor, a main memory, a non-volatile storage device, a network interface, and an interface to one or more external data sources. The terminal includes a processor, a display, an input device, and a communication interface. The user operates the terminal to input a prompt sentence and to view information returned from the server.

The server operates as an information processing apparatus executing one or more programs stored in the non-volatile storage device and loaded into the main memory. The programs are implemented, for example, using an operating system such as a general-purpose server operating system, and application software modules implemented in a high-level programming language. The server connects via a network (e.g., an IP-based local area network or a wide area network) to data storage systems such as relational databases, file servers, and message archives.
The server acquires attribute information, communication history information, and deliverable information regarding persons from multiple information sources. The server uses database client libraries (for example, a driver for a relational database system) to issue queries to a personnel database and a project database. The server also uses communication platform APIs, such as a generic messaging service API and an email service API, to retrieve message contents, sender and recipient identifiers, and timestamps. The server accesses document repositories through a file system protocol or an object storage API to obtain electronic files representing deliverables.
The server integrates the acquired information and stores the integrated information as recorded information. The server maintains a data storage structure, such as multiple relational tables or key-value collections, that associate each item of communication or deliverable with a person identifier and metadata describing the context of the item. By integrating heterogeneous data into a unified recorded information store, the server can later perform coordinated analysis across different types of information without repeatedly accessing external systems.
The server extracts character data from the recorded information. When the recorded information includes documents in different file formats, the server employs text extraction modules configured to parse formatted documents, emails, and transcripts, and convert them into plain text. For example, the server applies a document parser to a formatted document to obtain a stream of characters corresponding to titles, headings, and body paragraphs, and discards non-text elements such as images or vector graphics. The server similarly parses email headers and bodies to extract textual content, and parses message logs to extract conversational text.
The server normalizes an encoding format, a notation format, and a layout of the character data. The server converts all character data to a standard encoding (for instance, a single character set), standardizes representations of dates, numbers, and common abbreviations, and removes layout-specific constructs such as repeated whitespace and decorative line separators. The server removes unnecessary portions of character data, including signatures, generic disclaimers, automated system notifications, and other repeated boilerplate that do not contribute to the analysis. This normalization and cleaning reduce the size and variability of text inputs that must be processed, which in turn reduces memory usage and improves cache locality during later processing.
The server generates analysis target data to be input to a large-scale language model. The server structures the cleaned and normalized character data into logical text units, for example, segments corresponding to coherent topics within a communication thread or segments corresponding to sections of a deliverable. Each unit is associated with identifiers for persons involved and metadata such as timestamps and project identifiers. The server stores the analysis target data in a data structure such as a table or a collection separating text content, person identifiers, and contextual attributes. The normalization enables the large-scale language model to operate on a reduced and standardized input space, which improves inference accuracy and decreases the required computational resources.
The server divides the analysis target data into units and generates analysis data sets grouped on a person basis or a topic basis while controlling a token count or a character count in accordance with an input constraint of the large-scale language model. The server applies a tokenization function that maps sequences of characters into discrete tokens used by the large-scale language model. The server computes an estimated token count for each candidate text segment and merges or splits segments such that each analysis data set satisfies a maximum token count constraint determined by the language model architecture. When grouping on a person basis, the server aggregates text units associated with the same person until the token count reaches a threshold. When grouping on a topic basis, the server uses content similarity metrics (for example, cosine similarity between vector representations of text segments) to group units likely to discuss the same topic, again respecting the token limit.
The server inputs the analysis data sets into a large-scale language model and obtains analysis results including expertise information of the persons and relationship information between the persons. In one embodiment, the large-scale language model is a multi-layer transformer neural network comprising an embedding layer, a plurality of self-attention layers, and a final output projection layer. The model parameters are stored as numerical weight matrices in accelerator memory (such as a graphics processing unit or a tensor processing unit). The server passes token sequences to the model through a model serving interface and receives, for each token sequence, output vectors that represent contextualized embeddings for the tokens. The server applies additional classifier heads or decoding logic on top of the output vectors to derive labels such as skill categories and relationship indicators.
The server stores the analysis results as structured data. The server constructs a schema in which each person is represented by one or more records listing expertise information, each expertise item is represented by a normalized skill identifier, and each relationship is represented by records that link person identifiers with a relationship type and confidence value. The server writes these results into a persistent data store such as a relational database or a graph database. The structured storage allows efficient indexing and querying of expertise and relationships without requiring re-analysis of the original text.
The server generates a relationship structure indicating correspondences among the persons, skills, and relationships on the basis of the structured data and holds the relationship structure as a searchable knowledge representation. In one example, the server constructs a graph where person entities are nodes, skill entities are nodes, and edges represent associations such as a person possessing a particular skill or two persons having collaborated. The server maintains adjacency lists or edge tables that allow traversal from a given person to related persons or skills. The construction of a dedicated relationship structure, as opposed to simple flat tables, permits the server to execute graph traversal algorithms using fewer operations and to answer complex queries, such as finding persons at multiple degrees of separation, with improved computational efficiency.
The server receives a prompt sentence in a natural language input by a user. The user operates the terminal to access a user interface provided by the server, such as a web-based interface or a dedicated application interface. The user types a prompt sentence such as:
“Show me employees who have worked with Employee B on data integration projects.”
   or
“what Are the Main Areas of Expertise of Person A?”
   or
“Find three candidates with strong Python and cloud migration experience who collaborated with Person B in the past five years.”
   The terminal transmits the prompt sentence to the server via a communication protocol such as HTTPS. The server logs the prompt sentence together with session information and user access privileges.
   The server causes a generative AI model to generate an intermediate representation for converting the prompt sentence into a structured query including a search condition for the relationship structure. The generative AI model may be a sequence-to-sequence neural network or a transformer-based language model pre-trained on a large corpus and further fine-tuned on task-specific data mapping natural language requests to structured query representations. The server constructs an input to the generative AI model that includes a description of the available schema (for example, entity types and relationship types) and the user's prompt sentence. The generative AI model outputs an intermediate representation such as a key-value structure specifying the target entity type (persons), the required skills, the relationship type (e.g., collaboration), time constraints, and other filter conditions.
   The server performs a search process on the relationship structure on the basis of the intermediate representation obtained from the generative AI model. The server translates the intermediate representation into a structured query in a query language supported by the data store, such as a graph query language or a relational query language. The server executes the query against the relationship structure, traversing nodes and edges, and retrieves a set of matching persons and associated attributes. By delegating only the interpretation of the natural language prompt to the generative AI model and performing the actual data retrieval using deterministic queries over the relationship structure, the server constrains the behavior of the generative AI model and reduces the computational load placed on the model for each user request.
   The server generates a prompt sentence to input response data including the structured data obtained as a result of the search process into the generative AI model and obtains an answer sentence in the natural language from the generative AI model. The server constructs a second prompt sentence that includes the user's original question and a compact representation of the response data. For example, the server may generate an instruction such as:
“User question: ‘Show me employees who have worked with Employee B on data integration projects.’
Search results: Person C (department: IT, skills: data integration, SQL, ETL, common projects with B: CRM migration 2023); Person D (department: Data Engineering, skills: data integration, Python, cloud services, common projects with B: Data Lake build 2022).
   Generate a concise answer listing the persons and explaining briefly why each person matches.”
   The generative AI model receives this prompt sentence and outputs an answer sentence in the natural language. Because the server passes only structured data known to be correct and requires that the answer refer only to that data, the generative AI model acts as a natural language surface generator rather than an unconstrained knowledge source. The server returns the generated answer sentence to the terminal, and the terminal displays the answer sentence to the user.
   The server in some embodiments further instructs the generative AI model to use only identifiers and attributes present in the structured data when generating an answer sentence, and the server verifies that the content generated by the model does not include entities or attributes outside of the structured data. For example, after receiving a candidate answer sentence, the server parses the sentence to detect names or identifiers and confirms that each detected identifier appears in the previously retrieved structured data. If a mismatch is detected, the server may discard the answer and request regeneration with stricter constraints or provide a simplified answer. This verification reduces the likelihood of the generative AI model introducing information not supported by the stored data, thereby improving reliability.
   In another embodiment, the server uses the relationship structure to extract a set of persons satisfying predetermined skill conditions or project conditions based on skill information, project information, and collaboration history information included in the analysis results. For instance, the server may identify all persons who possess a skill corresponding to “generative AI model deployment” and have participated in at least one project with a particular collaboration pattern. The server then generates a prompt sentence that summarizes the attributes of these persons and requests the generative AI model to produce a comparative explanation. The user can thus obtain a human-readable explanation of why certain persons are suitable for a technical assignment, while the underlying selection is carried out using deterministic database operations.
   From a computer technology standpoint, the described configuration provides improvements beyond mere automation of human reasoning. By normalizing encoding, notation, and layout at the server, the system reduces variability in input text and improves the effectiveness of tokenization and embedding operations. This leads to a reduction in the number of tokens required to represent a given amount of information, which directly lowers computational cost and latency for the large-scale language model. By constructing and maintaining a relationship structure as a persistent, indexed data structure, the server allows many queries to be fulfilled by efficient graph or relational database operations without repeatedly invoking a large-scale language model. This separation of concerns reduces load on model-serving hardware and improves overall throughput.
   Furthermore, the use of an intermediate representation generated by the generative AI model to guide structured queries provides a technical effect in that the language model is used to translate between human language and machine query language, while retrieval logic remains deterministic and verifiable. This architecture reduces network traffic and response time compared to approaches that repeatedly send large textual contexts to the language model and rely on the model both to recall and to reason about information. The server can also cache intermediate representations or query results and reuse them for subsequent similar prompt sentences, further improving resource utilization.
   The neural network models used in the system, including the large-scale language model and the generative AI model, are configured with specific architectures and learning procedures. For example, each model may employ multiple attention heads, feed-forward layers with non-linear activation functions, and layer normalization, trained using a gradient-based optimization algorithm minimizing a loss function defined over prediction errors on next-token prediction or supervised instruction-response pairs. During fine-tuning for intermediate representation generation, the generative AI model can be trained on pairs of natural language requests and corresponding structured queries, with an objective function penalizing deviations from expected structured formats. Such training allows the model to produce machine-readable representations with high structural accuracy, reducing the need for complex parsing at runtime.
   The server in some variations applies additional rule-based post-processing to outputs of the large-scale language model and the generative AI model. For example, the server may use synonym dictionaries and hierarchical taxonomies of skills to normalize skill labels, or apply business rules specifying minimal confidence thresholds for relationship edges in the relationship structure. These rule-based operations differ from typical manual tagging procedures because they operate directly on model output distributions and structured representations, enabling automated resolution of conflicts and consolidation of results across multiple analysis batches. Alternative embodiments may vary in the choice of data storage technology, model deployment architecture, or query language, while still operating within the scope of the claims. The relationship structure may be implemented as a pure graph database, a relational schema with join tables, or a hybrid structure combining both. The large-scale language model and the generative AI model may be deployed on dedicated accelerator hardware within the same data center as the server or accessed as remote services through a secure network connection. The terminal may be a desktop computer, a mobile device, or a thin client, as long as it can transmit prompt sentences to the server and display answer sentences received from the server.
   By integrating these components and processing steps, the server, the terminal, and the user collectively implement a system that not only automates the extraction of expertise and relationships from large volumes of text but also improves the performance, accuracy, and manageability of the underlying computer infrastructure. The system optimizes data flows to language models, reduces redundant computation by leveraging a persistent relationship structure, and constrains generative models through verifiable intermediate representations, thus providing concrete technical advantages in information processing.

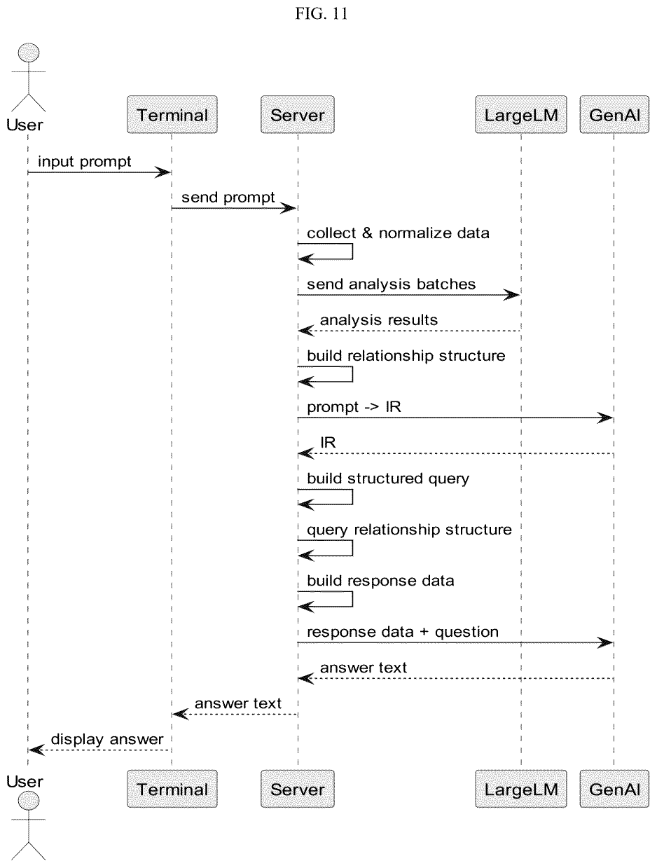

The following describes the processing flow using FIG. 11.

### Step 1:

The server acquires raw data from multiple information sources.
The input to Step 1 is a set of connections and access credentials to external data sources such as personnel databases, project databases, communication systems, and document repositories. The server uses database drivers and network APIs to send queries and API requests, and the output of Step 1 is a collection of raw records including attribute information, communication history information, and deliverable information linked to person identifiers.
The server issues structured queries to a personnel database to retrieve records including person identifiers, roles, departments, and declared skills. The server sends requests to a project database to obtain project memberships, roles, and project descriptions. The server calls messaging APIs to download message logs with sender and recipient identifiers, timestamps, and message bodies. The server accesses document repositories to list and download electronic files representing reports, presentations, and other deliverables. The server writes all retrieved items into a staging storage, tagging each item with a source type and an associated person identifier.

### Step 2:

The server extracts character data from the raw records and files.
The input to Step 2 is the collection of raw records and files stored by the server in Step 1. The server applies format-specific parsers and text extraction procedures to transform heterogeneous data into text strings, and the output of Step 2 is a set of text segments associated with person identifiers and metadata.
   The server parses structured database records to extract textual fields such as job descriptions, project summaries, and skill descriptions. The server uses mail parsers to extract email subjects and bodies from raw email formats. The server processes message logs to extract message text from conversation records. The server invokes document parsers for various file formats to read text content from formatted documents and presentations while discarding non-text elements. The server stores the resulting character data in an intermediate data store together with references to the original source items.

### Step 3:

The server normalizes the encoding, notation, and layout of the character data.
The input to Step 3 is the set of text segments produced in Step 2. The server applies normalization functions to unify text representations and remove noise, and the output of Step 3 is normalized character data ready for analysis.
   The server converts all text segments into a uniform character encoding. The server standardizes different date formats, number formats, and common abbreviations into consistent forms using lookup mappings. The server removes extraneous layout markers such as repeated whitespace, decorative lines, and HTML tags. The server identifies and removes unnecessary portions, including repetitive disclaimers, standard signatures, and system-generated notifications, using pattern matching rules. The server stores the cleaned and normalized text segments in a normalized text repository indexed by person identifiers.

### Step 4:

The server generates analysis target data units from the normalized character data.
The input to Step 4 is the normalized text repository created in Step 3. The server groups and segments the normalized text based on logical boundaries and person associations, and the output of Step 4 is a set of analysis target data units that combine text content with person-related metadata.
The server determines segmentation points based on document structure, conversation threads, or length thresholds. The server splits long text streams into smaller segments that preserve semantic coherence while avoiding excessive length. The server attaches identifiers for persons involved, topic identifiers if available, timestamps, and source types to each segment. The server records each segment as an analysis target data unit in a data structure that separates text content from metadata fields.

### Step 5:

The server tokenizes the analysis target data units and estimates token counts.
The input to Step 5 is the collection of analysis target data units from Step 4. The server applies a tokenizer corresponding to the large-scale language model to convert text into tokens and computes token counts, and the output of Step 5 is a set of tokenized units each annotated with its token count.
The server invokes a tokenizer function that segments each text string into discrete tokens according to model-specific rules. The server counts the number of tokens in each unit and records this information as part of the unit's metadata. The server uses these token counts to determine how to group units into analysis data sets that respect the maximum input size of the large-scale language model.

### Step 6:

The server generates analysis data sets by grouping tokenized units on a person basis or a topic basis.
The input to Step 6 is the set of tokenized units with token counts produced in Step 5. The server performs grouping and merging of units while enforcing token limits, and the output of Step 6 is a set of analysis data sets each containing one or more tokenized units.
The server, when grouping on a person basis, selects units associated with the same person identifier and accumulates units until adding another unit would exceed a predefined token limit for the language model. The server, when grouping on a topic basis, calculates similarity scores between units using vector representations or keyword overlaps to identify units likely to share the same subject, and then groups similar units together within the token constraint. The server labels each analysis data set with grouping criteria and related person identifiers and stores the sets in a batch queue for model analysis.

### Step 7:

The server inputs the analysis data sets to a large-scale language model and obtains analysis results.
The input to Step 7 is the batch queue of analysis data sets generated in Step 6. The server sends tokenized sequences to the large-scale language model and performs post-processing on model outputs, and the output of Step 7 is a collection of analysis results that capture expertise information and relationship information.
The server submits each analysis data set to a model serving component implementing a transformer-based neural network trained on text corpora. The server receives contextual output vectors from the model and applies classifier or extraction logic to derive structured labels such as skill tags, expertise categories, and indications of collaboration or communication relationships between persons mentioned in the text. The server generates confidence scores for each inferred skill or relationship based on model output probabilities and internal thresholds. The server stores the analysis results in a temporary result store keyed by person identifiers and analysis batch identifiers.

### Step 8:

The server converts the analysis results into structured data records.
The input to Step 8 is the collection of analysis results output by the large-scale language model in Step 7. The server maps inferred labels and relationships into predefined schemas, and the output of Step 8 is structured data records representing expertise and relationships.
The server normalizes variable textual labels for skills to controlled vocabulary entries using synonym mappings and hierarchical taxonomies. The server creates records that link person identifiers to normalized skill identifiers together with associated confidence scores. The server also creates records that link pairs of person identifiers with relationship types such as “collaborated” or “communicated frequently,” and assigns confidence values based on the analysis results. The server writes these records into persistent structured data stores such as relational tables or graph edge lists.

### Step 9:

The server constructs and maintains a relationship structure from the structured data.
The input to Step 9 is the set of structured records produced in Step 8. The server organizes these records into a relationship structure optimized for search, and the output of Step 9 is a searchable knowledge representation storing persons, skills, and relationships.
The server creates nodes representing persons and nodes representing skills and creates edges representing possession of skills and relationships between persons. The server assigns properties to nodes and edges such as identifiers, labels, and confidence values. The server builds indexes on node properties and edge types to accelerate search operations. The server periodically updates the relationship structure when new analysis results are added or existing records are revised, ensuring that the structure remains consistent and current.

### Step 10:

The user inputs a prompt sentence through the terminal.
The input to Step 10 is the user's information need, expressed in natural language. The user enters this information through an input interface, and the output of Step 10 is a prompt sentence transmitted from the terminal to the server.
The user may type a prompt sentence such as “Show me employees who have worked with Employee B on data integration projects” or “What are the main areas of expertise of Person A?” into a search box or chat interface displayed by the terminal. The terminal captures the typed text, associates it with the user's session information, and sends it as a request message to the server over a network connection.

### Step 11:

The server prepares input for a generative AI model to generate an intermediate representation.
The input to Step 11 is the prompt sentence received from the terminal in Step 10. The server creates a model input that combines the prompt sentence with schema information, and the output of Step 11 is a formatted input sequence sent to the generative AI model.
The server reads a description of the available entity types, relationship types, and searchable fields from configuration data. The server constructs an instruction string that explains how to convert a natural language question into a structured query representation and appends the user's prompt sentence. The server sends this composite input to the generative AI model via a model interface.

### Step 12:

The server obtains an intermediate representation from the generative AI model and validates it.
   The input to Step 12 is the output produced by the generative AI model in response to the formatted input in Step 11. The server parses this output and checks its consistency with expected formats, and the output of Step 12 is a validated intermediate representation of the user's request. The server examines the output to confirm that it specifies a target entity type, one or more conditions on skills or relationships, and any additional filters such as time ranges. The server verifies that the referenced field names correspond to known schema elements. If the representation is incomplete or contains unknown fields, the server may adjust it using default rules or request refinement from the generative AI model. Once validated, the server holds the intermediate representation as a structured object for subsequent query generation.

### Step 13:

The server translates the intermediate representation into a structured query for the relationship structure.

The input to Step 13 is the validated intermediate representation from Step 12. The server maps the representation to a query expression in a supported query language, and the output of Step 13 is a concrete structured query ready for execution.
The server identifies the base person identifiers, required skill identifiers, and relationship types from the intermediate representation. The server fills in a query template that joins or traverses relevant nodes and edges in the relationship structure. The server verifies that the query respects access controls based on the requesting user's privileges. The server then submits the structured query to the data store managing the relationship structure.

### Step 14:

The server executes the structured query and retrieves response data.
The input to Step 14 is the structured query generated in Step 13. The server runs the query against the relationship structure, and the output of Step 14 is response data containing matching persons and associated attributes.
The server performs graph traversals or relational joins as required by the query, following edges from a specified person node to related person nodes and filtering by skill nodes that match required skill identifiers. The server collects information such as names, departments, skills, and common projects for each matching person. The server assembles this information into a compact response data object, which contains only the fields needed for answer generation.

### Step 15:

The server generates an answer-generation prompt sentence that includes the response data.
The input to Step 15 is the response data obtained from the query in Step 14 and the original user prompt sentence from Step 10. The server constructs a new prompt sentence for the generative AI model, and the output of Step 15 is a composed instruction text containing both the question and the retrieved data.
The server embeds the user's question text and the list of matching persons with their attributes into a natural language template that instructs the generative AI model to produce a concise and accurate explanation. The server explicitly directs the model not to introduce entities or facts beyond those given in the response data. The server then sends this composed prompt sentence to the generative AI model.

### Step 16:

The server receives an answer sentence from the generative AI model and verifies it.
The input to Step 16 is the generated answer text returned by the generative AI model in response to the prompt of Step 15. The server analyzes the answer to ensure consistency with the response data, and the output of Step 16 is a verified answer sentence ready for presentation.
The server scans the answer sentence for mentions of person identifiers, skill names, and project names, and checks that each mention corresponds to a value present in the response data. If extraneous or unknown entities are detected, the server may truncate or regenerate the answer by adjusting the instructions. After verification, the server records the answer in a log for auditing and returns the verified answer sentence to the terminal.

### Step 17:

The terminal presents the answer sentence to the user.
The input to Step 17 is the verified answer sentence delivered by the server in Step 16. The terminal renders this text in the user interface, and the output of Step 17 is a displayed answer that the user can read and, if desired, refine with additional questions.
The terminal updates the display area of the chat or search interface with the answer sentence, often along with structured elements such as a list of names with clickable links to more details. The user can then decide to enter a follow-up prompt sentence, which will again be transmitted to the server and processed through the described sequence of steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented personnel assignment systems are typically limited to rule-based filtering or simple scoring functions that match candidates to predefined skill requirements. Such systems generally treat personnel records, communication logs, and deliverables as isolated data sources, and therefore cannot fully exploit latent relationships and collaboration patterns inherent in large, heterogeneous datasets. As a result, these systems often generate team proposals that lack robustness in real-world collaborative environments, produce suboptimal staffing decisions, and require extensive manual revision by human operators. Furthermore, when large language models and generative AI models are used in existing systems, they are frequently invoked in an ad hoc manner, with static or manually crafted prompts that are not adapted to historical performance of the model or to feedback from users. This leads to inconsistent output quality, lack of reproducibility, and an inability to systematically improve the behavior of the AI components over time. In particular, conventional systems do not provide a unified technical mechanism by which structured personnel data and project requirements are transformed into machine-readable prompt sentences, logged together with model responses, and iteratively refined to improve subsequent team composition results. In addition, known systems typically rely on the user to interpret AI-generated suggestions and to manually enforce constraints such as required skills, role coverage, personnel limits, and work conditions. This manual enforcement imposes cognitive load on the user and introduces latency and error into the staffing workflow. The computational resources of the server are not effectively utilized to automatically validate and optimize team proposals based on learned relationships between personnel, resulting in inefficient use of processing cycles and network bandwidth.

Accordingly, there is a need for a technical system that improves computer technology for team formation and personnel allocation by: (i) automatically integrating heterogeneous personnel-related data into structured data, (ii) programmatically constructing and managing prompt sentences for large language models and generative AI models, (iii) using AI-derived relationship and specialty information to algorithmically generate and refine team compositions under explicit computational constraints, and (iv) logging prompts and responses to enable adaptive adjustment of prompt generation and team-generation parameters. By addressing these issues, the server can perform more reliable, consistent, and efficient computation for team composition, reduce user burden, and improve the overall performance and predictability of AI-assisted staffing operations.
The specific processing by the specific processing unit 290 of the data processing device 12 in Application Example 1 is realized by the following means.
The present invention provides a server comprising a processor and a memory storing instructions that, when executed by the processor, cause the processor to acquire information including personnel attribute information, communication history information, and deliverable information from at least one storage resource, integrate the acquired information and perform preprocessing to generate structured data, generate a machine-readable prompt sentence for inputting the structured data to a large language model or a generative AI model, input the structured data to the large language model or the generative AI model by using the prompt sentence, and analyze the structured data by using the large language model or the generative AI model to generate analysis result data identifying relationships between personnel and specialty fields or strengths of individual personnel, generate team composition information including combinations of a plurality of personnel and roles of the respective personnel for a project, based on the analysis result data and requirement information related to the project, transmit the team composition information to a terminal device, acquire correction instruction information or approval instruction information from a user via the terminal device, update or finalize the team composition information based on the correction instruction information or the approval instruction information, and record the prompt sentence and response content from the large language model or the generative AI model as log data and adjust generation conditions of the prompt sentence or generation conditions of the team composition information based on the log data. This enables the server to technically improve computer-implemented staffing operations by automatically transforming heterogeneous input data into structured AI-ready representations, programmatically controlling and refining prompt sentences and AI calls, generating and optimizing team compositions under explicit computational constraints, adaptively improving model interaction based on logged prompts and responses, and thereby reducing manual intervention, enhancing consistency and reproducibility of AI outputs, and increasing the overall efficiency and reliability of the team formation computation.
The term “processor” refers to a hardware computation unit, or a combination of hardware computation units, that executes machine-readable instructions, and may include one or more central processing units, graphics processing units, or other processing circuitry.
The term “memory” refers to a non-transitory computer-readable storage medium, or a combination of such media, configured to store data and instructions executable by the processor, and may include volatile memory and non-volatile memory.
The term “personnel attribute information” refers to structured or unstructured data describing characteristics of an individual worker, including at least skills, past project experience, areas of expertise, roles previously held, and any other profile-related information used for team composition.
The term “communication history information” refers to data representing past electronic communications between personnel, including at least messages, emails, chat logs, or similar textual exchanges, together with associated metadata such as sender, recipient, timestamp, and communication channel.
The term “deliverable information” refers to data associated with work products produced by personnel, including at least documents, reports, specifications, design files, presentations, or other digital artifacts, and text or metadata extracted therefrom.
The term “storage resource” refers to any device or service capable of storing and providing data to the server, including at least local storage devices, network-attached storage, database systems, and external information providing services.
The term “preprocessing” refers to a series of computer-executed operations that convert raw data into a normalized or cleaned form, including at least parsing, filtering, noise removal, normalization of labels, and transformation into a target data structure.
The term “structured data” refers to data organized according to a predefined schema or format, such as a table, record, or hierarchical object, in which fields such as personnel identifiers, skills, communication samples, and deliverable samples are explicitly represented.
The term “large language model” refers to a machine learning model trained on large-scale text data to perform natural language understanding and generation tasks, and capable of receiving text input and producing text output based on statistical patterns.
The term “generative AI model” refers to an artificial intelligence model configured to generate output data, including textual, structured, or semi-structured content, from input data, and includes at least large language models that produce natural language or structured representations.
The term “prompt sentence” refers to a machine-readable text or data structure that encodes instructions, context, and input data for a large language model or a generative AI model, and that is provided as part of an input message to control the behavior and output format of the model.
The term “analysis result data” refers to data generated by the large language model or the generative AI model through analysis of structured data, including at least inferred relationships between personnel, inferred strengths or weaknesses of personnel, and inferred specialty fields of individual personnel.
The term “relationships between personnel” refers to information indicating how personnel are associated with or interact with each other, including at least collaboration frequency, cooperation patterns, mentor-mentee relations, or potential conflicts inferred from communication history or other data.
The term “specialty fields” refers to one or more technical, functional, or domain areas in which an individual personnel member exhibits expertise or particular proficiency, as determined from attribute information, project history, or deliverable information.
The term “strengths” refers to capabilities, skills, or behavioral characteristics of personnel that are identified as relatively strong or advantageous in comparison with other capabilities of the same personnel or within a target group.
The term “project requirement information” refers to data describing conditions and constraints for a target project, including at least required skills, required roles, number of personnel, time frame, work conditions, and any additional constraints for team composition.
The term “team composition information” refers to data representing at least one proposed grouping of personnel for a project, including identifiers of personnel in each group, assigned roles for the personnel, and optionally evaluation or rationale related to the grouping.
The term “role” refers to a functional position or responsibility assigned to personnel within a team or project, including at least leadership roles, coordination roles, and specialist roles.
The term “terminal device” refers to an information processing apparatus operated by a user, including at least a personal computer, a mobile terminal, or any client device capable of communicating with the server over a communication network.
The term “correction instruction information” refers to data received from the terminal device indicating user-initiated modifications to proposed team composition information, including at least changes in assigned personnel, assigned roles, or team structure.
The term “approval instruction information” refers to data received from the terminal device indicating that the user has accepted or confirmed at least part of the proposed team composition information as final or approved.
The term “log data” refers to records automatically generated by the server that store operational information including at least prompt sentences, responses from the large language model or the generative AI model, timestamps, and identifiers related to processing sessions.
The term “generation conditions of the prompt sentence” refers to parameters, rules, or templates used by the server to construct prompt sentences, including at least instruction content, context selection, formatting rules, and output specification requirements.
The term “generation conditions of the team composition information” refers to computational parameters or rules used by the server to create or refine team composition information, including at least constraints on skills, roles, number of personnel, work conditions, and evaluation criteria for candidate teams.
The term “selection reason information” refers to data describing the rationale for including particular personnel in a team or assigning particular roles, including at least references to skills, specialty fields, past collaboration, or other analysis result data.
The term “analysis target information” refers to data provided to the large language model or the generative AI model for analysis, including at least the structured data representing personnel, communication history information, deliverable information, and project requirement information.

In one embodiment, a server cooperates with at least one terminal and at least one user to implement the claimed system. The server includes at least one processor and at least one memory. The processor executes instructions stored in the memory to perform data acquisition, data preprocessing, prompt sentence generation, interaction with a generative AI model, analysis result post-processing, and team composition generation. The terminal includes at least one display, at least one input interface, and communication circuitry. The terminal presents generated team composition information to the user and transmits user instructions back to the server.

The server runs on general-purpose computing hardware such as an x86_64-based or ARM-based computer having a multi-core central processing unit and optional graphics processing units. The server uses an operating system such as a general-purpose server operating system. The memory includes volatile memory such as random access memory and non-volatile memory such as a solid-state drive. The server is connected to a communication network such as an IP-based network, and is coupled to data repositories such as a relational database system, a document storage system, and a log storage system.
The server uses application software including at least a database management system (for example, a relational database engine), a document parsing library (for example, a word processing file parser, a presentation file parser, a portable document format parser), a text processing library (for example, tokenization, normalization, and pattern matching components), and an AI client library that communicates with a generative AI model hosted on a remote inference service. In another embodiment, the server includes a local inference engine that executes the generative AI model on a local accelerator.
The server stores personnel attribute information, communication history information, and deliverable information in different logical data structures. The server represents personnel attribute information as records in database tables having fields such as personnel identifier, skill labels, years of experience, project identifiers, and role histories. The server represents communication history information as messages in tables or documents with fields such as sender identifier, receiver identifier, timestamp, channel identifier, and message text. The server represents deliverable information as document metadata and associated text segments with fields such as author identifier, project identifier, creation time, and extracted textual content.
The server applies preprocessing operations to the stored data. The server uses parsing modules to extract text from documents. The server uses text normalization modules to remove markup, stop words, headers, and repetitive signatures. The server uses mapping tables to map synonymous skill labels and project names to canonical identifiers. The server uses statistical analysis modules to compute communication frequencies and co-occurrence statistics between pairs of personnel. The server transforms these heterogeneous data sources into structured data objects, for example, hierarchical records in which each record aggregates attributes, communication summaries, and deliverable summaries for a given personnel identifier.
The server generates internal feature representations from the structured data. The server represents skills and roles as categorical indices, represents communication frequencies as numerical features, and represents deliverable categories as binary or multi-valued indicators. The server embeds textual descriptors (for example, short summaries of deliverables or communication excerpts) into vector representations by invoking a text embedding model. These embeddings are stored as multidimensional numerical arrays in memory. By using such feature representations, the server reduces the dimensionality of raw text and enables efficient similarity computations between personnel.
The server uses a generative AI model configured as a transformer-based neural network. The generative AI model includes an input embedding layer, a plurality of self-attention layers, feed-forward layers, and a final output projection layer. The generative AI model has been trained using a large corpus of text and task instructions, using a training procedure such as mini-batch gradient descent with backpropagation. The training uses a loss function such as cross-entropy between predicted tokens and reference tokens, and updates model parameters including attention weights, layer normalization parameters, and feed-forward weights. In an additional fine-tuning phase, the model may be trained on domain-specific personnel and project descriptions, where the loss function also considers the correctness of structured outputs, such as team composition fields.
The server constructs a prompt sentence for the generative AI model. The server generates the prompt sentence by combining a task instruction segment, a constraint segment, and a data segment. The task instruction segment describes the analysis to be performed, the constraint segment specifies requirements such as output format and coverage of skills, and the data segment summarizes or references the structured data representing personnel. The server creates the prompt sentence as natural language text, which is then transmitted as part of a request to the generative AI model.
For example, the server can generate a prompt sentence such as:
“Analyze the following employee information, including skills, past project experience, communication patterns, and work products. Identify each employee's main strengths, secondary skills, collaboration relationships, and suitable roles in a factory project. Then propose an optimal team composition for launching a new product line, ensuring that all required skills are covered and that collaboration relationships are respected. Provide the result in a structured textual format with clearly labeled sections: ‘Teams’, ‘Members’, ‘Roles’, and ‘Rationale’. The employee information is as follows: [textual description of employees].”
   In another example, the server can generate a prompt sentence such as:
“You are an assistant that designs project teams based on employee profiles. From the description below, extract each employee's technical strengths, weaknesses, and past collaboration partners. Then construct one or more candidate teams for the specified project, explain why each member is assigned to each role, and highlight any potential collaboration risks. Output your answer in plain text, with one section titled ‘Analysis’ and another section titled ‘Team Proposal’.”
   The server sends the prompt sentence and the associated structured data to the generative AI model through a communication interface. The server receives a generated response, which typically includes textual descriptions of relationships, strengths, and proposed team compositions. The server converts the generated response into internal structures by parsing marker phrases and section headers, or by using pattern matching rules. In certain embodiments, the server requests the generative AI model to produce output in a pseudo-structured text form that is easier to parse deterministically.
   The server applies post-processing algorithms to the parsed analysis result data. The server verifies that each proposed team covers the required skill categories and required roles specified in project requirement information. The server computes an objective function value for each team composition, where the objective function incorporates factors such as coverage of necessary skills, redundancy of critical roles, historical collaboration frequency between selected members, and balance of workload based on available working hours. The server may use a heuristic optimization algorithm such as greedy selection, local search, or simulated annealing to adjust team compositions. For example, the server can iteratively replace members with alternative candidates if the objective function improves.
   The server records the prompt sentence and the generative AI model response as log data. The log data includes at least the full text of the prompt sentence, a timestamp, an identifier of the model version, a hash of the input structured data, and quality indicators such as user approval of the resulting team composition. The server stores this log data in a log database. The server subsequently analyzes the log data to adjust prompt generation conditions. For example, the server can detect that certain phrasing patterns in prompt sentences correlate with higher user approval, and then adjust templates to favor those phrasing patterns. The server can also detect patterns of constraint violations and add explicit instructions in subsequent prompt sentences to reduce such violations.
   By systematically logging prompts and responses and feeding this information back into prompt generation logic, the server improves the consistency of outputs and reduces the number of iterations required to obtain acceptable team compositions. This feedback-driven prompt adjustment is performed by algorithms that calculate statistics over the log data, such as frequencies of successful outcomes for different prompt templates, and then update configuration parameters that control template selection. In this way, the server modifies its own behavior without retraining the generative AI model itself, thereby providing a more stable and controllable AI interaction layer.
   The server transmits the final or intermediate team composition information to the terminal. The terminal renders the team composition information on a display using interactive user interface components. The terminal may employ user interface frameworks to display teams in table format, chart format, or hierarchical list format. The terminal enables the user to select and expand a particular team, inspect the roles assigned to each member, and read the rationale explaining why each member was selected. The terminal transmits user inputs, such as modifications to team membership or reallocation of roles, back to the server as structured commands.
   The server incorporates the user modifications into its internal data structures. The server may optionally re-evaluate the modified team composition using the same objective function used for the automatically generated proposals, thereby computing a quality measure for user-modified teams. The server updates log data with information about which AI proposals were accepted, which were modified, and what kind of modifications were performed. This information is later used to adjust prompt generation conditions or weighting parameters in the objective function. The system yields technical effects beyond mere automation of human decision-making. First, by converting heterogeneous personnel, communication, and deliverable data into integrated structured data with embedded feature representations, the server reduces communication and storage overhead. Vector embeddings enable compact representation of text content, resulting in lower memory usage and faster similarity computations relative to manipulating raw full-text.
   Second, by using a generative AI model controlled through systematically designed prompt sentences and feedback-driven prompt adjustments, the server produces more accurate and more stable team compositions than systems that rely on static rule-based matching. The generative AI model makes use of its high-dimensional attention mechanisms to capture complex dependencies between skills, collaboration patterns, and roles, which are not captured by simple scoring formulas.
   Third, the server optimizes overall computation by offloading large-scale language understanding to the generative AI model, while executing deterministic constraint checking and optimization locally. This division of labor ensures that the expensive generative inference is called only with carefully prepared summarized data, minimizing network traffic and reducing overall processing time compared to repeated trial-and-error interactions manually initiated by the user. Fourth, the feedback-driven adjustment of prompt generation conditions and team composition parameters leads to a reduction in the number of inference calls and user revisions required over time, thereby lowering both computational load and user interaction time.
   In another embodiment, the server executes a locally hosted generative AI model. In such a configuration, the server uses a deep learning framework to implement a transformer-based neural network with a fixed number of layers and heads. The server loads trained model parameters from a model file stored in memory. When the processor executes inference, the processor performs matrix multiplications, attention weight computations, and non-linear transformations on token embeddings. The server may employ mixed-precision arithmetic and optimized linear algebra libraries to accelerate inference. By hosting the model locally, the server reduces network latency and achieves deterministic response times, which is beneficial for interactive team composition scenarios.
   In yet another embodiment, the server uses an ensemble approach. The server invokes a primary generative AI model for natural language analysis, and also applies a rule-based module and a smaller classifier network to validate or refine the generative output. The classifier network may be a feed-forward neural network trained on historical classification labels such as “valid team”, “incomplete team”, or “over-constrained team”. The classifier network uses as input features the counts of covered skills, overlap ratios between team members'roles, and statistics derived from the communication network, such as average path length between team members in a collaboration graph. This ensemble approach further improves reliability by detecting anomalous or low-quality generative outputs and triggering corrective actions.
   In a further embodiment, the server supports multiple project types and different constraint profiles. The server stores configuration profiles for different project categories, such as high-safety projects, high-throughput production lines, or research-oriented initiatives. Each profile defines different priorities and weights for skills, redundancy, collaboration history, and risk factors. The server selects an appropriate profile based on the project requirement information. The generative AI model is instructed, through the prompt sentence, to consider the selected profile when producing team compositions. As a result, the server tailors team proposals to the specific operational characteristics of the target project, using technical configuration parameters instead of manual ad hoc tuning.
   The terminal may be implemented as a mobile device in a factory environment. The terminal can receive real-time updates from the server when changes in personnel availability occur, such as sickness absences or shift changes. The server updates structured data and re-evaluates team compositions using updated availability constraints. The server transmits revised compositions to the terminal, allowing the user to rapidly adapt staffing. This dynamic adaptation is enabled by the combination of fast preprocessing, efficient feature representations, and prompt-controlled generative inference, and leads to reduced downtime and improved utilization of equipment and human resources.
   Across these embodiments, the server applies specific data structures, algorithms, and model interaction techniques to implement the claimed system. The server does not merely execute generic data retrieval and display, but rather transforms input data into optimized internal representations, orchestrates complex inference calls to a generative AI model through prompt sentences, and applies rigorous constraint-handling and optimization algorithms to derive technically improved team compositions. The combination of structured data integration, transformer-based generative analysis, prompt feedback logging, and constraint-aware optimization results in measurable improvements in accuracy, speed, and resource utilization relative to conventional systems that do not employ these techniques.

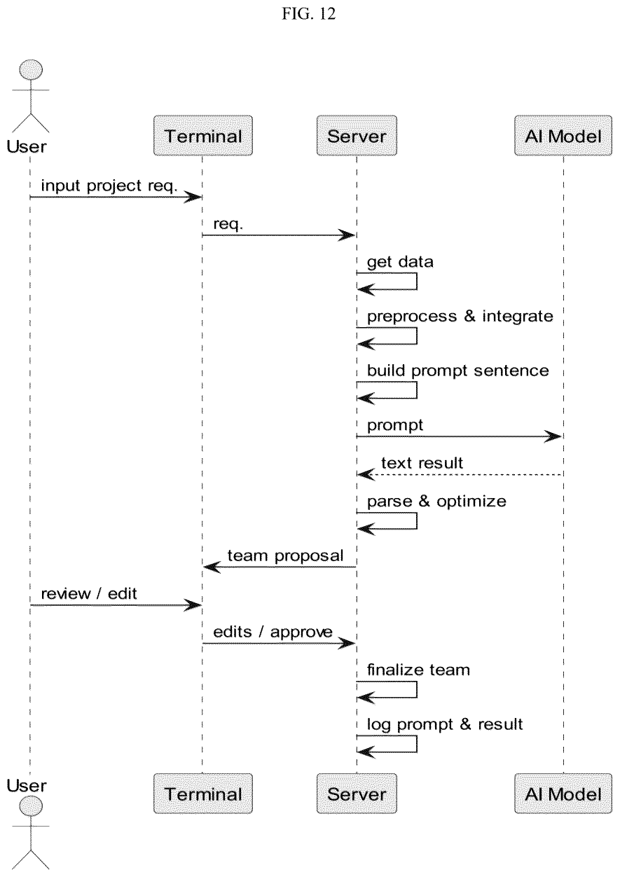

The following describes the processing flow using FIG. 12.

### Step 1:

The server acquires raw data from storage resources. As input, the server receives database records containing personnel attribute information, message logs containing communication history information, and document files containing deliverable information. The server issues database queries, file system reads, and API calls to retrieve these inputs. The server outputs a set of raw data objects, including personnel records, communication messages, and document contents, stored in working memory.

### Step 2:

The server preprocesses and normalizes the acquired data. As input, the server uses the raw data objects output from Step 1. The server removes noise such as headers and signatures from text, maps synonymous skill names to canonical labels, and extracts plain text from documents using parsing modules. The server performs data operations including string filtering, tokenization, label mapping, and timestamp normalization. The server outputs cleaned and normalized data structures for personnel, communication, and deliverables.

### Step 3:

The server integrates heterogeneous data into structured data per personnel. As input, the server uses the normalized personnel, communication, and deliverable data from Step 2. The server joins these inputs by personnel identifiers and project identifiers, aggregates communication samples and deliverable summaries, and builds hierarchical records for each personnel entry. The server performs data aggregation operations such as grouping, counting communication frequencies, and linking deliverables to authors. The server outputs structured data objects in which each object represents an integrated profile for one personnel.

### Step 4:

The server generates internal feature representations. As input, the server uses the structured data from Step 3. The server encodes skill labels as categorical indices, converts communication frequencies into numerical features, and classifies deliverables into categories using rule-based or simple classifier logic. The server optionally calls a text embedding component to transform short text excerpts into numerical vectors. The server performs numerical operations such as vectorization, normalization, and concatenation of features. The server outputs feature-augmented structured data in which each personnel profile includes both symbolic fields and numeric feature vectors.

### Step 5:

The server receives project requirement information from the terminal. As input, the user operates the terminal to enter project details, including required skills, required roles, preferred team size, and work conditions, through a graphical user interface. The terminal sends the user input as a structured request to the server over a network connection. The server parses the request and validates the fields. The server outputs a standardized project requirement object that is stored in memory.

### Step 6:

The server constructs a prompt sentence for a generative AI model. As input, the server uses the feature-augmented structured data from Step 4 and the project requirement object from Step 5. The server selects relevant personnel based on basic filtering (for example, skill presence or availability), summarizes their profiles into concise textual descriptions, and embeds these summaries into a task instruction template. The server performs string concatenation, template filling, and length control to ensure that the prompt sentence fits model input limits. The server outputs a complete prompt sentence that describes the analysis task and includes personnel information in natural language format.

### Step 7:

The server communicates with the generative AI model. As input, the server uses the prompt sentence from Step 6. The server packages the prompt sentence into an API request message, attaches model parameters (such as model identifier and decoding settings), and sends the request to the generative AI model endpoint via a network interface. The generative AI model performs transformer-based inference internally and returns a generated text response. The server receives this response as text. The server outputs the raw model response text, which contains analysis result descriptions and proposed team compositions.

### Step 8:

The server parses the generative AI model response into analysis result data. As input, the server uses the raw response text from Step 7. The server detects section markers, keywords, or line patterns that indicate personnel strengths, relationships, and team proposals. The server applies parsing rules and pattern matching to extract structured elements such as personnel identifiers, roles, rationales, and relationship descriptions. The server performs text segmentation, regular expression matching, and mapping back to internal personnel identifiers. The server outputs analysis result data structures that explicitly represent inferred strengths, weaknesses, relationships between personnel, and candidate team compositions.

### Step 9:

The server validates and refines team composition information. As input, the server uses the analysis result data from Step 8 and the project requirement object from Step 5. The server checks whether each candidate team satisfies constraints such as required skills, required roles, maximum team size, and work conditions. The server computes an objective score for each team using numeric functions that combine skill coverage, redundancy, collaboration strength, and workload balance. The server performs iterative refinement operations, such as swapping personnel between teams or replacing members with alternatives, to improve the objective score while maintaining constraints. The server outputs one or more optimized team composition objects, each including team members, assigned roles, and justification attributes.

### Step 10:

The server generates and stores log data for AI interaction. As input, the server uses the prompt sentence from Step 6, the raw response text from Step 7, the analysis result data from Step 8, and metadata such as timestamps and project identifiers. The server constructs log records that associate each prompt sentence with its corresponding generative AI model response and subsequent acceptance or modification status. The server performs data operations including record creation, hashing of structured data, and insertion into a log database. The server outputs persistent log entries that are stored for later analysis.

### Step 11:

The server adjusts generation conditions based on historical logs. As input, the server uses accumulated log entries from Step 10. The server calculates statistics such as success rates of different prompt templates, frequencies of constraint violations, and patterns of user modifications. The server performs statistical analysis, clustering, or simple machine learning on the log data to identify effective and ineffective prompt patterns. The server then updates configuration parameters, such as template selection rules, phrasing options, and constraint emphasis levels, in its prompt generation module and team optimization module. The server outputs updated configuration settings that influence future prompt sentence construction and composition algorithms.

### Step 12:

The server transmits team composition information to the terminal. As input, the server uses the optimized team composition objects from Step 9. The server formats these objects into a response payload containing team lists, member identifiers or names, assigned roles, and rationales. The server sends this payload to the terminal over the communication network. The terminal receives the payload, parses it, and outputs a user interface view displaying the teams to the user on a display device.

### Step 13:

The user reviews and optionally modifies the team composition information via the terminal. As input, the user observes the team composition information rendered on the terminal display and interacts using input devices such as a keyboard, mouse, or touch screen. The user may reassign personnel between teams, change roles, or edit rationales through the graphical user interface. The terminal records the modifications as structured edit commands and transmits them to the server over the network. The terminal outputs updated team configuration data and user instruction information to the server.

### Step 14:

The server processes user correction and approval instructions. As input, the server uses the user instruction information and updated team configuration data from Step 13, together with the prior optimized team compositions from Step 9. The server merges the user modifications into its internal team composition objects, validates that the modifications do not violate critical constraints, and, if required, recomputes objective scores. The server then marks specific team compositions as approved or finalized based on user approval instructions. The server outputs final team composition records and updates in the production database.

### Step 15:

The server updates internal metrics based on finalized team compositions. As input, the server uses the final team composition records from Step 14 and the corresponding log records from Step 10. The server labels each interaction as successful, partially modified, or rejected, and associates these labels with the respective prompt sentences and generative AI model responses. The server recalculates performance metrics, such as average number of user modifications per proposal and average computation time per finalized team. The server outputs updated performance metrics and stores them for monitoring and further system optimization.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional expert recommendation systems in organizations typically rely on manually maintained skill catalogs, keyword-based matching, or static rules. Such approaches suffer from multiple technical limitations when implemented on computer systems. First, conventional systems are not able to efficiently exploit heterogeneous data sources, such as relational storage, log data, and work management systems, in a unified manner, leading to suboptimal utilization of stored attribute information, skill information, and work history information. Second, conventional matching algorithms primarily rely on literal keyword coincidence and shallow text search, which are not well suited for processing natural language problem descriptions submitted by users, and which fail to capture semantic relationships between a user's problem and stored component profiles. This results in low precision and recall in the selection of relevant components, thereby degrading the quality of system outputs. Third, conventional systems generally lack an integrated mechanism for automatically constructing and controlling prompt sentences for a generative AI model based on both component information and user problem information. Without such a mechanism, the generative AI model input is under-specified, inconsistent, or noisy, leading to unstable or irreproducible ranking results and unnecessary computational overhead on the model-serving infrastructure. Fourth, many known systems do not incorporate feedback regarding actual user selections or subsequent interactions into the expert recommendation pipeline. As a result, the system is unable to adjust preprocessing operations or prompt sentence construction based on empirical performance, and thus cannot improve its behavior over time in a data-driven manner.

From a computer-technology perspective, these limitations manifest as inefficient use of processing resources, suboptimal data processing pipelines, and inadequate control of model invocation. A processor is required to perform multiple independent operations to access data, normalize it, and invoke external inference services, often without a coherent architecture that links preprocessing, model prompting, and postprocessing. This leads to increased latency, redundant computation, and difficulties in scaling the system for large organizations. There is therefore a need for a computer-implemented technique that integrates data acquisition, natural language preprocessing, generative AI model prompting, and ranking-based postprocessing, and that further incorporates user feedback in order to improve the technical performance of expert recommendation on a processor-based system.

The specific processing by the specific processing unit 290 of the data processing device 12 in Example 2 is realized by the following means.

The present invention provides a server comprising a processor configured to acquire, from at least one storage device and at least one management device, component information relating to an organization, the component information including data representing attribute information, skill information, and work history information, and to collect and integrate the data as unified component information; to perform preprocessing including natural language processing on the component information and on problem description information obtained from a user, to generate summary information of the component information, and to calculate a relevance between the problem description information and the summary information; to construct a prompt sentence based on the problem description information and the summary information, the prompt sentence being configured to instruct a generative AI model to select internal components, to input the prompt sentence to the generative AI model, and to obtain analysis result information including at least one component identifier and relevance information; to acquire detailed attribute information of each component from the storage device based on the component identifier included in the analysis result information, and to rank the components based on the relevance information; to generate recommendation information including the component identifier, the attribute information, and expertise information of ranked components, and to transmit the recommendation information to a user terminal for display; and, in some embodiments, to receive selection information indicating a component selected by the user based on the recommendation information, to store the selection information as record information, and to adjust at least one of the prompt sentence and the preprocessing based on the record information so as to improve a subsequent recommendation process for components. This enables an integrated and technically improved expert recommendation pipeline on a processor-based system, in which heterogeneous organizational data is normalized and summarized, generative AI model resources are invoked through systematically constructed prompt sentences, recommendation results are ranked and enriched for presentation on a user terminal, and feedback-driven adaptation of preprocessing and prompting improves the efficiency, accuracy, and scalability of component selection over time.

The term “processor” refers to a hardware or virtual computing unit, such as a central processing unit or a processing core in a server or computing device, that executes instructions to perform data acquisition, data processing, model invocation, and communication functions described in the present specification.

The term “storage device” refers to a hardware or logical data storage resource, such as a database system, file system, or non-volatile memory, that stores component information, attribute information, skill information, work history information, and record information used by the processor.
The term “management device” refers to an information processing system, such as a business management system, project management system, or workflow management system, that manages operational data relating to components in an organization and provides such data to the processor.
The term “component information” refers to data relating to elements within an organization, including but not limited to individuals, groups, or organizational units, and encompassing their attributes, skills, and work histories.
The term “attribute information” refers to data describing basic properties of a component, such as a name, role, title, organizational affiliation, or other identifying or descriptive characteristics.
The term “skill information” refers to data describing capabilities of a component, such as technical skills, domain expertise, proficiencies, and corresponding levels or durations of experience.
The term “work history information” refers to data describing past activities of a component, including project participation, tasks performed, responsibilities, and associated results or outcomes.
The term “unified component information” refers to a data set in which attribute information, skill information, and work history information obtained from different storage devices or management devices are collected, normalized, and integrated into a coherent representation for each component.
The term “problem description information” refers to text or other data provided by a user that expresses an issue, question, or task for which the user seeks assistance or a solution.
The term “preprocessing” refers to processing operations performed on component information and problem description information prior to model inference, including but not limited to text normalization, tokenization, parsing, feature extraction, keyword extraction, summarization, and encoding.
The term “natural language processing” refers to computational techniques for analyzing and transforming human language text, including operations such as tokenization, part-of-speech tagging, lemmatization, named entity recognition, semantic analysis, and text summarization.
The term “summary information” refers to a condensed representation of component information, generated by preprocessing, and including salient attributes, skills, and work history elements in a format suitable for relevance calculation and model input.
The term “relevance” refers to a degree or measure indicating how closely component information, including summary information, is related to or appropriate for the problem description information.
The term “prompt sentence” refers to a structured textual input, including instructions, problem description information, and component-related information, that is constructed by the processor and provided to a generative AI model to cause the generative AI model to perform a specified analysis or selection task.
The term “generative AI model” refers to a machine learning model, such as a large language model, that generates outputs including text or structured data in response to input data, and that is capable of performing semantic analysis, reasoning, and ranking based on the prompt sentence.
The term “analysis result information” refers to data output by the generative AI model in response to the prompt sentence, including at least one component identifier and associated relevance information or explanatory information.
The term “component identifier” refers to data that uniquely identifies a component within the system, such as an ID, code, or other unique key used to retrieve detailed information from a storage device.
The term “relevance information” refers to data describing a relevance relationship between a component and the problem description information, such as a numeric score, ranking, or explanatory text.
The term “detailed attribute information” refers to additional or more granular attribute information for a component, retrieved based on the component identifier, and usable for enriching recommendation information and for display to the user.
The term “ranking” refers to ordering components according to a criterion, such as relevance information or scores provided by the generative AI model, so that more suitable components are placed ahead of less suitable components.
The term “recommendation information” refers to data generated by the processor that specifies one or more components proposed to address the problem description information, including for each component at least a component identifier, attribute information, and expertise information.
The term “expertise information” refers to information describing specialized knowledge or technical fields associated with a component, derived from skill information, work history information, or analysis result information.
The term “user terminal” refers to an information processing device operated by a user, such as a client computer, mobile device, or other communication terminal, that receives and displays recommendation information and transmits problem description information and selection information.
The term “selection information” refers to data indicating which component or components a user has chosen from the recommendation information, such as identifiers of selected components and contextual details of the selection.
The term “record information” refers to stored data representing past selection information, user interactions, or system responses, which is used to adjust preprocessing or prompt sentence construction.
The term “technical field” refers to a category of technology, discipline, or domain, such as a programming area, engineering category, or business domain, that corresponds to the content of the problem description information.
The term “area of expertise” refers to a more specific subset of a technical field, such as a particular tool, framework, or specialized technique, associated with a component's skills or work history.
The term “subsequent recommendation process” refers to a later execution of operations by the processor to recommend components for a new or different problem description, where such operations may be influenced by record information from earlier recommendations.

In one embodiment, a server implements the claimed system on a hardware platform including at least one processor, a main memory, a non-volatile storage device, and a network interface. The server uses a commercial operating system such as a general-purpose server operating system, and application software such as a web application framework, a relational database management system, and a machine learning runtime environment. The server is connected via a network to at least one terminal, such as a client computer or a mobile communication device, operated by a user.

The server uses a database engine, such as a relational database system, as a storage device to store component information including attribute information, skill information, and work history information. The server defines, in this storage device, tables or equivalent data structures that contain, for example, a component table, a skill table, and a work history table. The component table includes records having fields such as a component identifier, a name field, a role field, and an organizational unit field. The skill table includes a component identifier field, a skill label field, a proficiency level field, and an experience duration field. The work history table includes a component identifier field, a project identifier field, a project description field, a technology field, and a role description field. The server uses a database driver to execute structured queries and to obtain result sets in the form of in-memory records or hierarchical data structures such as dictionaries or lists.
The server uses at least one management device, such as a project management system or workflow management system, to obtain additional work history information. The server communicates with such a management device via an application programming interface over a communication network. The server retrieves, for example, recent task descriptions, issue titles, and comments associated with components, and merges this information with the work history information stored in the relational database. The server normalizes identifiers, such that identifiers used by the management device are mapped to component identifiers used by the relational database, thereby forming unified component information for each component.
The server uses a natural language processing library running on the processor to perform preprocessing on the component information and problem description information. The server stores text fields, such as skill descriptions and project descriptions, as character strings in memory, and applies tokenization, part-of-speech tagging, lemmatization, and stop word removal to these character strings. The server further computes term-frequency inverse-document-frequency values for tokens derived from the unified component information, and generates a vector representation of each component profile in a high-dimensional numerical feature space. The server similarly preprocesses problem description information received from the terminal, such that the problem description is transformed into a normalized text form and then into a numerical feature vector. The server uses these vector representations to calculate preliminary relevance scores, for example, via cosine similarity, to filter out components whose preliminary relevance is below a threshold. This computation reduces the number of profiles that the server passes to the generative AI model, thereby decreasing communication load, inference time, and memory usage.
The server constructs, in memory, a prompt sentence to be provided to a generative AI model. The server concatenates textual segments including: (i) an instruction describing the task to be performed by the generative AI model; (ii) a representation of the problem description information; and (iii) summaries of candidate component profiles. The server generates each component summary by selecting a subset of fields from the unified component information, such as the role, key skills, and a limited number of work history entries, and by forming a concise textual description. An example of such a prompt sentence is as follows:

### System:

You are a generative AI model that recommends internal experts in an organization.
   User problem:
“I have a question about data analysis in Python.”

### Instruction:

Based on the following member profiles, recommend up to 3 members who are most suitable to answer this question.
Consider skills, project histories, and job titles.
   Member profiles:
1) ID: 123, Name: A, Title: Data Scientist
   Skills: Python, data analysis, machine learning
   Projects: “Time-series sales forecasting, customer churn prediction.”
2) ID: 456, Name: B, Title: Backend Engineer
   Skills: server-side development, database design
   Projects: “API development, database optimization.”

### Output:

Return a list of recommended members. For each member, output:
   member_id
   score (0 to 1, higher is better)
   reason (short explanation in English).
Japanese explanation:
   “I have a question about data analysis in Python. Recommend a member who is most suitable to answer this question.”
      The server embeds, in the prompt sentence, specific output constraints that require the generative AI model to output a structured format, such as explicit member identifiers and numeric relevance scores. This structure allows the server to parse the output deterministically without relying on heuristic pattern matching, thereby improving robustness and processing speed.

In one embodiment, the server implements the generative AI model as a large-scale neural network deployed on a separate computation node including one or more graphics processing units. The generative AI model comprises a transformer-based architecture with multiple attention layers, feed-forward layers, and layer normalization units. The model uses subword tokenization to convert the prompt sentence into a sequence of discrete tokens, and then processes this sequence through multiple self-attention operations to generate contextualized hidden representations. The model has been pre-trained on a large corpus of text via a language modeling objective, which minimizes a cross-entropy loss between predicted tokens and actual tokens, with parameters updated using a gradient-based optimization method such as Adam. Subsequently, the model may be fine-tuned on domain-specific data representing internal expert recommendation interactions, where the model is trained to generate outputs containing component identifiers and associated rationale sentences. The fine-tuning uses a supervised loss function that compares generated outputs with target outputs, and updates model weights to reduce prediction errors.

The server uses a machine learning runtime, such as a tensor computation framework, to invoke the generative AI model through an inference API. The server transmits the prompt sentence as a sequence of tokens to the inference engine, which runs on specialized hardware. The inference engine performs matrix multiplications, attention weight calculations, and non-linear activations according to the transformer architecture, and returns a generated sequence of tokens that form the analysis result information. In this way, the server does not merely automate a human's manual matching; instead, the server uses a high-dimensional embedding space and non-linear attention mechanisms to capture semantic relationships which are not accessible through simple keyword matching or rule-based logic, thereby improving both the precision and stability of recommendations.
The server parses the generated tokens from the generative AI model response and reconstructs the analysis result information into internal data structures, such as arrays of objects representing components. Each object includes at least a component identifier, a numerical score, and a textual reason. The server validates that each component identifier corresponds to an existing component in the relational database, and discards any identifiers that do not pass validation. The server then retrieves detailed attribute information for each valid component from the storage device, including, for example, department, role, and contact information, and merges it with the score and reason returned by the generative AI model.
The server sorts, in memory, the list of candidate components in descending order of the numerical score, and generates recommendation information. This recommendation information comprises a ranked list, in which each entry contains a component identifier, attribute information, expertise information inferred from skill information and work history information, and the textual reason derived from the analysis result information. The server serializes the recommendation information into a structured data format and transmits it via the network interface to the terminal, using a communication protocol such as HTTP over transport-layer security.
The terminal comprises a processor, a display, an input device, and a communication interface. The terminal receives the recommendation information from the server, decodes it, and presents a graphical user interface. The terminal displays, for example, a list of components, each with a name, role, organizational unit, and a one-line explanation indicating why the component is recommended. The terminal provides selectable interface elements, such as buttons, that allow the user to initiate communication with a selected component through an external communication application, such as an electronic mail client or an instant messaging application. Thus, the terminal converts the server's data processing results into a tangible user interface on an electronic display, where the user can perform further actions that are not practical through human-only manual matching.
The user operates the terminal to input problem description information using a keyboard, a pointing device, or a touchscreen. The terminal sends the problem description information to the server, and, after receiving the recommendation information, the user selects one of the recommended components through the graphical user interface. The terminal transmits selection information, including at least the component identifier and optional metadata such as a timestamp or context, back to the server.
The server stores the selection information as record information in the storage device. The server logs associations between problem descriptions, selected components, and recommendation scores. Over time, the server uses the accumulated record information to adjust the preprocessing and prompt sentence construction. For example, the server updates a mapping between tokens in the problem description and technical fields, based on which recommended components were actually selected by users. The server adjusts thresholds applied in the preliminary filtering stage, and modifies weighting factors used to generate component summaries. The server also modifies the template portions of the prompt sentence, such as by emphasizing certain fields (for example, particular skills or project outcomes) that historically correlate with successful recommendations. By explicitly encoding such feedback into the query and prompting pipeline, the server improves the efficiency and accuracy of subsequent recommendations, thereby achieving a technical improvement in the functioning of the computer system itself, rather than merely changing a business process.

In another embodiment, the server incorporates a dedicated feature extraction module that computes, for each component and each problem description, a joint representation comprising both symbolic and continuous features. The symbolic features may include counts of occurrences of certain skill categories, while continuous features may include embeddings produced by a separate neural encoder. The server uses a multi-step algorithm: first, the server computes these joint representations; second, the server uses them to select a smaller subset of components for inclusion in the prompt sentence; third, the server encodes the joint representation values as annotations in the prompt sentence, for example by stating scores or tags next to each component profile. This non-conventional combination of structured pre-filtering and annotated prompting reduces the number of tokens in the prompt sentence and guides the generative AI model towards more relevant candidates, leading to lower latency and reduced computational workloads on the model-serving hardware.

In yet another embodiment, the server implements a custom training procedure for the generative AI model or a smaller auxiliary model. The server uses the record information as supervised training data, where each training example includes a problem description, a set of candidate components, and labels indicating which component was selected by the user. The server defines a loss function that penalizes the model if it assigns a lower predicted relevance to the actually selected component than to non-selected components. The server uses gradient-based optimization to update the model parameters in the direction that decreases this loss. This training procedure causes the model to adapt to the organization-specific patterns of component selection and improves the alignment between relevance scores and actual user selections. As a result, the processor consumes fewer computational resources per successful recommendation, and the system produces more accurate results with fewer iterations.
In alternative embodiments, the server may use different types of generative AI models, such as encoder-decoder architectures or models trained via reinforcement learning with human feedback, provided that the models accept a prompt sentence as input and produce analysis result information including at least a component identifier and relevance information. The server may also use different natural language processing toolchains, segmentation algorithms, or similarity metrics, such as character-based models or approximate nearest neighbor search in embedding space, to implement the preprocessing and relevance calculation steps. These variants all satisfy the essential structure that the server integrates multiple data sources into unified component information, preprocesses this information together with problem description information, constructs a structured prompt sentence for a generative AI model, receives structured analysis result information, and uses this information to generate and refine recommendation information. By tightly coupling data structures, preprocessing algorithms, prompt sentence construction, generative AI model invocation, and feedback-based adaptation, the server improves the functioning of the computer system in terms of processing speed, precision of matching, and resource utilization. The server reduces unnecessary model invocations, decreases the amount of data transmitted to and from the generative AI model, and increases the reliability of parsing and ranking, which constitutes a technical improvement beyond mere automation of human expert selection.

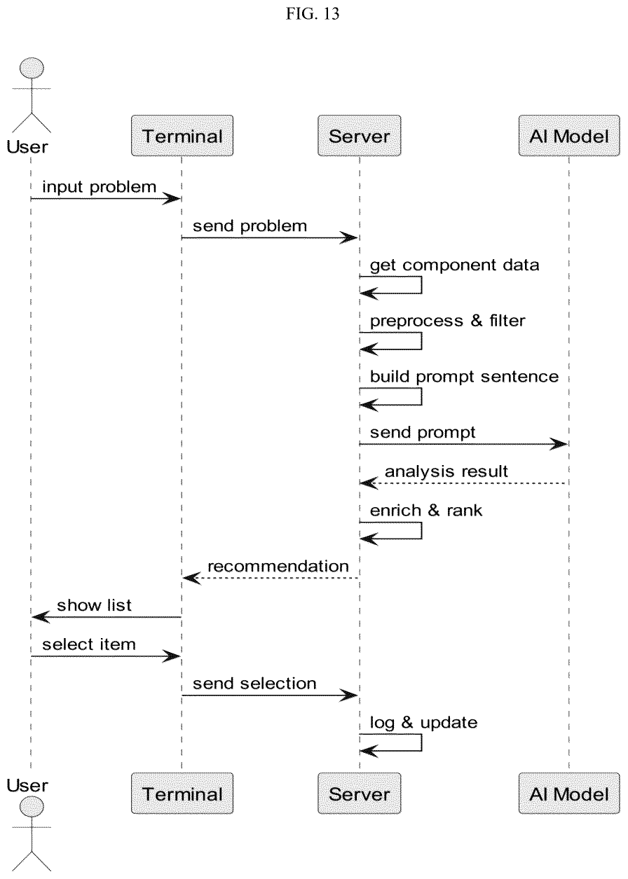

The following describes the processing flow using FIG. 13.

### Step 1:

The user operates the terminal to input problem description information.
The user enters, for example, a text such as “I have a question about data analysis in Python” into an input field displayed on the terminal. The terminal receives this textual input as a character string (input) and associates it with metadata such as a user identifier and a timestamp. The terminal converts the input into an internal data object and performs basic validation, such as checking that the string is not empty and does not exceed a maximum length. The terminal then prepares this problem description information as part of a request payload (output) to be sent to the server.

### Step 2:

The terminal transmits the problem description information to the server.
The terminal uses a communication interface to encapsulate the problem description information and associated metadata into a request message (input) conforming to a predefined communication protocol. The terminal serializes this data (for example, into a structured text format) and sends it to a server endpoint over a secure communication channel. The terminal waits for a response from the server. The server receives the request message (output of this step) and stores the problem description information in working memory for further processing.

### Step 3:

The server acquires component information from storage and management devices.
The server uses the problem description information (input) only as a trigger and then connects to at least one storage device and at least one management device. The server issues structured queries to the storage device to retrieve attribute information, skill information, and work history information for components. The server also calls interfaces of management devices, such as project management systems, to obtain recent work-related records. The server maps identifiers between systems and merges records belonging to the same component. The server performs data integration operations, such as joining tables on component identifiers and consolidating redundant records. The server generates unified component information objects (output) for all components, each object containing linked attribute, skill, and work history fields.

### Step 4:

The server preprocesses the component information and the problem description information. The server takes as input the unified component information and the problem description information. The server applies natural language processing to text fields, including tokenization, lowercasing, lemmatization, and removal of stop words. The server builds term-frequency inverse-document-frequency vectors for tokens extracted from component skill descriptions and project descriptions. The server converts the problem description into a corresponding vector using the same vocabulary and weighting scheme. The server computes preliminary similarity scores, for example via cosine similarity, between the problem description vector and each component vector. Based on these similarity scores, the server filters out components whose score is below a predetermined threshold. The server outputs: (i) a subset of candidate components with higher preliminary relevance, and (ii) normalized text summaries for each candidate component.

### Step 5:

The server constructs summary information and a prompt sentence for the generative AI model.
The server uses, as input, the normalized text summaries of candidate components and the normalized problem description. The server generates summary information by selecting salient fields (for example, main skills and key projects) and concatenating them into concise descriptions. The server then assembles a prompt sentence by placing: (i) an instruction section specifying the recommendation task; (ii) a section quoting the problem description; and (iii) a section listing the component summaries with component identifiers. The server appends explicit output format constraints, such as requiring the generative AI model to output a list of component identifiers, scores, and reasons. The server outputs a fully constructed prompt sentence that is suitable for tokenization and inference by the generative AI model.

### Step 6:

The server invokes the generative AI model with the prompt sentence.
The server uses the prompt sentence (input) and passes it to a generative AI model hosted on a model-serving infrastructure. The server requests tokenization of the prompt sentence and forwards the tokens through an inference API to a transformer-based neural network. The generative AI model processes the token sequence, performing attention computations and feed-forward transformations to generate an output token sequence. The server receives the output token sequence, reconstructs it into textual analysis result information, and parses it according to the requested output format. The server extracts from the analysis result information a set of component identifiers, numerical relevance scores, and textual explanations (output).

### Step 7:

The server post-processes the analysis result information and enriches it with detailed attributes.
The server takes the analysis result information (input) and validates each component identifier against the storage device. The server removes any identifier that does not match an existing component. The server issues additional queries to the storage device to retrieve detailed attribute information and expertise information corresponding to the valid identifiers. The server merges the retrieved attributes, such as role, organizational unit, and contact information, with the relevance scores and explanations produced by the generative AI model. The server sorts the merged records by the numerical relevance score in descending order. The server outputs a ranked recommendation information object that contains, for each recommended component, the identifier, attributes, expertise information, and a reason.

### Step 8:

The server transmits recommendation information to the terminal.
The server uses the ranked recommendation information (input) and serializes it into a response message. The server sends this response over the network interface to the terminal that initiated the request. The server may log the size and processing time of the recommendation information for monitoring and optimization. The terminal receives the response message (output of this step) and passes it to its user interface module.

### Step 9:

The terminal displays the recommendation information to the user.
The terminal takes the recommendation information (input) and parses it into in-memory structures suitable for rendering. The terminal generates user interface elements, such as a list view, where each entry displays a component's name, role, organizational unit, expertise summary, and explanatory reason. The terminal orders the entries according to the ranking information. The terminal draws these elements on the display, updates any scrollable regions, and enables interactive elements such as “Contact” buttons. The terminal outputs a fully rendered screen that the user can view and interact with.

### Step 10:

The user selects a recommended component and initiates follow-up actions.
The user observes the displayed recommendation information (input to the user) and chooses one of the components shown. The user activates, for example, a “Contact” button associated with a particular component. The terminal detects this user action and may launch a communication application with pre-filled fields referencing the selected component. The terminal also creates selection information, including the selected component identifier and contextual data, which becomes output from this step and input to the next step.

### Step 11:

The terminal transmits selection information to the server.
The terminal uses the selection information (input) generated from the user's interaction and packages it into a request message. The terminal sends this message to the server over the network interface. The terminal may tag the message with a session identifier to associate the selection event with the original problem description. The server receives the selection information (output of this step) for logging and learning purposes.

### Step 12:

The server records selection information and updates internal parameters.
The server uses the selection information (input) and stores it as record information in the storage device. The server associates the selected component identifier with the original problem description and the recommendation scores that were produced during that recommendation cycle. The server aggregates these records over time and computes statistics, such as how often components with certain skills are chosen for particular types of problem descriptions. Based on these statistics, the server updates parameters of the preprocessing pipeline, such as weights for certain tokens, and adjusts templates used to construct the prompt sentence. The server outputs updated configuration data or model parameters that will be used in future executions, thereby modifying internal behavior to improve accuracy, efficiency, and relevance in subsequent recommendations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information recommendation and expert-finding systems typically rely on static rule engines or simple keyword matching between user queries and stored profiles or documents. Such systems suffer from several technical drawbacks.

First, conventional systems are not able to integrate heterogeneous data sources, such as structured human resource records, semi-structured communication logs, unstructured work products, and time-series sensor data from equipment, into a unified internal representation that can be effectively exploited in real time. As a result, the systems often fail to identify the most relevant person or response plan when the context involves complex relationships between people, machines, and past incidents.
Second, conventional systems treat queries and internal data in an isolated manner and do not automatically generate optimized prompt sentences for interaction with advanced generative AI models. Instead, either no generative AI model is used, or a fixed, manually crafted prompt is applied, leading to suboptimal use of the model's reasoning capability. This causes low accuracy in identifying required expertise, ranking candidate persons, and formulating response plans, particularly in dynamic environments such as industrial facilities.
Third, conventional systems generally ignore the user's emotional state when computing recommendation results. The lack of emotion-aware logic means that the system cannot adjust priority or selection criteria in accordance with the user's frustration, stress, or other emotional conditions. This can degrade the effectiveness and usability of the system, for example by suggesting technically suitable but practically unsuitable contacts for a distressed user in a time-critical failure scenario.
Fourth, conventional systems typically do not maintain a feedback loop that uses the output of the generative AI model and actual performance information from the internal database to update evaluation values for candidate persons and response plans. Without such an adaptive mechanism, the system cannot improve over time and cannot dynamically refine future prompt content or recommendation results based on observed outcomes, which limits the technical performance of the recommendation engine.
Fifth, with respect to equipment failures, existing systems often require manual intervention to correlate sensor anomalies with required skills and appropriate experts. The systems do not automatically detect events from sensor data, invoke both a large-scale language model and a generative AI model to estimate failure causes and required capabilities, and then automatically notify a suitable person's terminal device. This leads to higher latency in failure response and increased load on human operators.
Accordingly, there is a need for an improved computer-implemented system and server architecture that (i) fuses multi-type data into integrated internal data, (ii) analyzes relationships, expertise, equipment states, and failure contents using a large-scale language model, (iii) automatically constructs optimized prompt sentences for a generative AI model, (iv) adaptively updates evaluation values and future prompts based on model outputs and performance data, and (v) performs emotion-aware and event-triggered expert recommendation and notification. Such improvements are directed to enhancing the technical functioning of the computer system itself, including improved data processing efficiency, higher relevance and precision of recommendations, faster automated responses to equipment failures, and adaptive behavior over time.

The specific processing by the specific processing unit 290 of the data processing device 12 in Application Example 2 is realized by the following means.

The present invention provides a server comprising a processor configured to collect and preprocess information from multiple heterogeneous data sources, including information regarding capabilities of human resources, information regarding equipment, information regarding communication, information regarding outcomes, and information regarding emotions, and to generate integrated internal data from the collected information; to analyze, on the basis of the integrated internal data, relationships between persons and areas of expertise as well as states and failure contents of equipment by using a large-scale language model; to automatically generate, on the basis of the large-scale language model and an analysis result, a prompt sentence optimized for a generative AI model, to input the prompt sentence into the generative AI model, and to cause the generative AI model to output at least one of a candidate person, a candidate worker, and a candidate response plan; to collate at least one of the candidate person, the candidate worker, and the candidate response plan with attribute information of persons, operation history information, and performance information stored in an internal database, to select a person having at least one of a specific area of expertise and a specific capability, and to generate result information including contact information regarding the person and a reason for recommendation; to adjust a priority of at least one of the selected person and the candidate response plan in accordance with an inquiry content input by a user and the information regarding emotions, and to generate response information including a recommendation result according to an emotional state; to update an evaluation value of at least one of the candidate person and the candidate response plan on the basis of the output acquired from the generative AI model and the performance information stored in the internal database, and to dynamically change, on the basis of the updated evaluation value, content of generation of future prompt sentences and future recommendation results; and to detect, on the basis of sensor data or abnormality notification from equipment, an event regarding equipment failure, to use the large-scale language model and the generative AI model in response to occurrence of the event to estimate a cause of the failure and a required capability, to specify a person having at least one of a specific area of expertise and a specific capability on the basis of the estimation, and to transmit notification information to a terminal device of the specified person. This enables the computer system to automatically transform heterogeneous raw data into an integrated representation, to exploit both a large-scale language model and a generative AI model through dynamically generated prompt sentences, to provide emotion-aware and context-sensitive recommendations with reduced latency, to adapt its evaluation and prompting strategy over time based on actual outcomes, and to improve the technical performance of expert identification and failure response processing executed by the server.

The term “system” refers to a combination of one or more computing devices and associated software components that cooperate to execute the processing defined in the claims.

The term “server” refers to an information processing apparatus including at least one processor and a memory, the apparatus being configured to execute programs that implement the collection, analysis, and generation functions defined in the claims.
The term “processor” refers to one or more hardware processing units, such as a central processing unit or similar computing circuitry, configured to execute instructions stored in a memory to perform the steps recited in the claims.
The term “terminal device” refers to an information output and input apparatus, such as a client computer, portable information device, or wearable device, that communicates with the server and displays or transmits information for a user.
The term “internal data” refers to data generated by the processor through collection and preprocessing of multiple kinds of input information, the data integrating information regarding human resources, equipment, communication, outcomes, and emotions into a unified representation.
The term “information regarding capabilities of human resources” refers to data indicating attributes of persons, including at least skill categories, experience, roles, and past operations or activities relevant to tasks or problem solving.
The term “information regarding equipment” refers to data relating to physical apparatus or machines, including at least configuration information, operational state, error histories, and sensor measurements.
The term “information regarding communication” refers to data representing interactions between persons, including at least messages exchanged via electronic mail, text communication systems, or similar digital communication channels.
The term “information regarding outcomes” refers to data representing results of operations or tasks, including at least documents, reports, designs, or other work products generated by persons.
The term “information regarding emotions” refers to data indicating an estimated emotional state of a user, such as frustration, calmness, or joy, obtained from user input or analysis of signals including text, audio, or image information.
The term “large-scale language model” refers to a machine-learned model trained on a large amount of natural language data and configured to analyze or generate text, which the processor uses to infer relationships between persons, areas of expertise, and states or failures of equipment.
The term “generative AI model” refers to a machine-learned model that receives a prompt sentence as input and generates output data including at least text representing candidate persons, candidate workers, or candidate response plans.
The term “prompt sentence” refers to a text sequence automatically constructed by the processor, including at least a representation of internal data and analysis results, and provided as input to the generative AI model to cause the generative AI model to generate an output required by the system.
The term “relationships between persons” refers to logical or inferred connections among persons, including at least collaboration patterns, communication patterns, or co-occurrence in tasks, as determined by analysis using the large-scale language model.
The term “areas of expertise” refers to fields or domains of knowledge in which a person has skills or experience, as inferred from internal data by the large-scale language model.
The term “states of equipment” refers to conditions of equipment operation, including at least normal operation, degraded operation, and abnormal behavior, as indicated by equipment-related information.
The term “failure contents of equipment” refers to details of malfunction or abnormality in equipment, including at least error types, symptom descriptions, and associated operational context.
The term “candidate person” refers to a person identified by the generative AI model as potentially suitable for addressing a query, requirement, or event defined in the prompt sentence.
The term “candidate worker” refers to a subset of candidate persons who are identified as suitable for execution of specific tasks or operations in an environment such as an industrial site.
The term “candidate response plan” refers to a plan, procedure, or set of recommended actions output by the generative AI model in response to a prompt sentence, the plan being directed to handling a query, problem, or failure.
The term “internal database” refers to a data storage subsystem accessible by the processor, storing at least attribute information of persons, operation history information, performance information, and other internal data used in analysis and collation.
The term “attribute information of persons” refers to data items describing each person, including at least identification information, organization information, skill categories, and role categories.
The term “operation history information” refers to data describing past operations or activities of persons or equipment, including at least task assignments, project participations, and incident handling records.
The term “performance information” refers to data indicating outcomes or effectiveness of persons or response plans, including at least success indicators, completion times, and quality evaluations associated with past events.
The term “result information” refers to data generated by the processor after selection of a person, the data including at least contact information of the selected person and a reason for recommendation.
The term “contact information” refers to data enabling communication with a person, including at least an electronic address, a telephone number, or an account identifier in a communication system.
The term “reason for recommendation” refers to an explanation or justification generated by the processor, indicating factors or analysis results that support selection of a particular person or response plan.
The term “inquiry content” refers to information representing a request or question input by a user, including at least a description of a problem, a required capability, or a desired response.
The term “priority” refers to an order or weight assigned by the processor to at least one of a person or a response plan, the order or weight being used to rank or select among multiple candidates.
The term “emotional state” refers to a classification of the user's emotion, such as stress level or satisfaction, determined from information regarding emotions.
The term “response information” refers to data generated by the processor that includes at least a recommendation result and is intended to be transmitted to and displayed by the terminal device.
The term “evaluation value” refers to a numerical or categorical indicator maintained by the processor for at least one of a candidate person and a candidate response plan, the indicator reflecting estimated usefulness or reliability based on model outputs and performance information.
The term “event regarding equipment failure” refers to an occurrence detected by the processor from sensor data or an abnormality notification, indicating that equipment is in or approaching an abnormal or failed state.
The term “sensor data” refers to measurement data acquired from sensing components associated with equipment, including at least values of physical quantities such as vibration, temperature, current, or position.
The term “abnormality notification” refers to data generated by equipment or a monitoring subsystem that indicates detection of an anomaly, error, or warning condition.
The term “required capability” refers to a capability or skill type inferred by the processor as necessary or desirable for handling a particular failure, problem, or query.
The term “notification information” refers to data transmitted by the processor to a terminal device of a specified person, including at least an indication of an event, a summary of a failure or problem, and a request for response or action.

In one embodiment, a server, a terminal, and a communication network cooperate to implement the claimed system. The server includes at least one processor, a main memory storing programs and models, and a non-volatile storage storing databases and log data. The terminal includes at least one processor, a display, an input interface, and a communication module configured to exchange data with the server via a wired or wireless network.

The server uses a general-purpose processor, such as a multi-core central processing unit, and optionally a graphics processing unit for acceleration of neural-network inference. The server stores in the memory a large-scale language model and a generative AI model. In one embodiment, the large-scale language model has a transformer architecture comprising multiple self-attention layers, feed-forward layers, and layer-normalization units, with parameters trained on a large corpus of natural-language documents. The generative AI model is also implemented as a transformer-based neural network configured to accept a prompt sentence as an input token sequence and to output a probability distribution over next tokens. The server stores the parameters of the models as weight matrices, bias vectors, and embedding tables in a model storage region of the non-volatile storage.

The server uses a database management system, such as a relational database system, to store integrated internal data. The internal data is stored in normalized relational tables, for example: a person table containing person identifiers, role attributes, and capability attributes; an equipment table containing equipment identifiers, configuration attributes, and state attributes; a communication table containing message identifiers, sender and receiver identifiers, and message-summary fields; an outcome table containing document identifiers, project identifiers, and derived feature fields; and an emotion table containing user identifiers, time stamps, and emotion labels. The server maintains indices over key columns, such as person identifiers and equipment identifiers, to accelerate join operations and selection operations.
The server executes a program that configures the processor to collect and preprocess heterogeneous information. The server obtains information regarding capabilities of human resources from the person table and related tables. The server obtains information regarding equipment from sensor streams, log files, and equipment controllers through network protocols, and inserts normalized records into the equipment table and associated sensor tables. The server obtains information regarding communication from mail servers, chat servers, or ticketing systems, converts semi-structured messages into plain text, and stores message metadata and extracted features into the communication table. The server obtains information regarding outcomes from file repositories or document management systems, extracts text contents and structural metadata, and stores identifiers and features into the outcome table. The server receives information regarding emotions from the terminal in the form of text, audio-derived features, or image-derived features, or computes such information locally using a sentiment analysis model or a separate emotion recognition model, and stores emotion labels and scores into the emotion table.
The server performs data preprocessing using specific software components. The server uses a natural-language processing library, such as a tokenizer and tagger, to segment sentences, tokenize words, and assign part-of-speech tags to text from communication data and outcomes. The server applies named-entity recognition models to detect candidate entities such as skill names, equipment names, error codes, project identifiers, and location names. The server converts these detected entities into normalized feature vectors or categorical codes and stores them into corresponding columns or feature vectors in the internal database. The server normalizes time stamps into a unified time representation and encodes categorical variables such as roles, departments, and equipment categories into integer indices used by the models.
The server uses the large-scale language model to analyze the integrated internal data. The server constructs intermediate text sequences that represent, for each person, a concatenation of skill-related phrases, summaries of past projects, and summaries of communication contents, and for each piece of equipment, a concatenation of configuration descriptions, recent sensor-derived anomaly phrases, and error summaries. The server feeds these sequences to the large-scale language model in a batched fashion. The model internally computes self-attention scores between tokens, generates contextual embeddings, and outputs latent representations corresponding to tokens or sentence-level embeddings. The server projects these embeddings into vector spaces representing relationships between persons, areas of expertise, and equipment states. The server stores these projected vectors as numerical feature vectors in the internal database, thereby augmenting each person record and each equipment record with high-dimensional embeddings that represent relationship patterns and expertise characteristics.
The server configures the generative AI model to operate with a specific decoding strategy, such as beam search with a fixed beam width, constrained by maximum token length and probability thresholds. The server maintains a prompt-construction module that builds a prompt sentence for each request context by concatenating template text with selected internal data and analysis results. The server uses rule-based selection and learned scoring functions to choose which pieces of internal data to include in the prompt sentence, in order to stay within token limits while preserving relevant context. The use of embeddings and pre-computed relationship vectors enables the server to select compact, representative summaries rather than raw text, reducing communication load and inference cost while preserving accuracy.
The server generates a prompt sentence by applying deterministic assembly rules. For example, when the server analyzes a machine failure, the server generates a prompt sentence of the form:
“You are a diagnostic assistant. Analyze the following machine failure and required expertise. Machine state: [summarized sensor data, error codes, and recent state changes]. Historical incidents: [brief summaries of similar past incidents]. User request: ‘Find an engineer who can troubleshoot abnormal vibration on machine X.’ Based on the above, list the required skills, relevant expertise domains, and criteria to choose the best expert.”
   When the server identifies an expert based on user-specified criteria, the server generates a prompt sentence of the form:
“You are an HR assistant. The user asked: ‘Find a person with more than 5 years of data-science experience.’ Internal candidate profiles: [Candidate 1: skills, years, projects]; [Candidate 2: skills, years, projects]. Analyze these profiles and rank the candidates. Explain briefly why each top candidate matches.”
   When the server performs task assignment considering emotional state, the server generates a prompt sentence of the form:
“You are a task allocation planner. The user is currently in a frustrated emotional state. Worker skill profiles: [summaries of each worker's skills and experience]. Current tasks and priorities: [summaries of pending tasks and severities]. Assign tasks so that highly skilled and calm workers handle the most critical issues and the frustrated user receives clear, supportive assistance.”
   The server inputs the generated prompt sentence to the generative AI model, which transforms the prompt sentence into token embeddings, performs multiple layers of self-attention and feed-forward processing, and outputs a sequence of tokens representing a candidate person list, a candidate worker list, or a candidate response plan. The server decodes the token sequence into text using a vocabulary mapping and applies post-processing rules to identify structured items such as person names, skill labels, and recommended actions. The server maps these items back to internal identifiers using fuzzy-matching and embedding similarity, thereby combining the free-form model output with structured database records.
   The server collates the candidate persons and candidate response plans with attribute information and operation history information stored in the internal database. The server retrieves candidate person records and computes ranking scores using a weighted combination of model-derived confidence scores, years of experience, number of relevant past incidents handled, and similarity between current equipment state embeddings and incident embeddings. The server generates result information including contact information of top-ranked persons and textual explanations synthesizing the reasoning, such as “recommended because of prior experience with similar vibration failures on comparable equipment.” The server adjusts the priority of persons or plans by applying correction factors based on the user's emotional state, for example decreasing the rank of persons whose historical communication style embeddings correlate with low satisfaction in prior interactions when the user is already frustrated.
   The server updates evaluation values associated with persons and response plans. The server records, for each recommendation, an evaluation value reflecting performance information such as resolution success, response time, and user feedback. The server periodically aggregates these evaluation values and updates weight parameters used by the ranking module. In one embodiment, the server uses a gradient-based optimization method to adjust scoring coefficients so that predictions align more closely with observed outcomes. This feedback loop enables the processor to dynamically change, over time, the content of future prompt sentences and recommendation strategies: for example, the server may increase the weight of certain features (such as number of similar incidents resolved) while reducing the reliance on others (such as generic seniority) based on measured effectiveness.
   The server detects events regarding equipment failures by monitoring sensor data streams and abnormality notifications from equipment. The server uses threshold-based rules and anomaly detection algorithms, such as statistical deviation detection or autoencoder-based reconstruction error thresholds, to classify time segments as normal or abnormal. Once the server detects an event regarding equipment failure, the server constructs an event description from sensor features and error codes and generates a prompt sentence as described above, instructing the generative AI model to estimate potential failure causes and required capabilities. The server then uses the large-scale language model embeddings and the generative AI model output together to identify persons whose expertise and historical incident embeddings align with the required capability. The server transmits notification information to terminal devices of the specified persons, including a concise description of the event, suggested initial actions, and a reference to prior similar cases.
   The terminal displays the response information received from the server, including lists of recommended persons, candidate response plans, and explanations. The terminal presents interactive elements to the user, allowing the user to initiate communication with selected persons using e-mail, messaging, or voice calls. The terminal can also send additional user feedback and emotion-related information back to the server, which the server uses to further refine its models and evaluation values.
   The described configuration improves computer technology in several ways. The integration of heterogeneous data into structured internal data combined with transformer-based embeddings allows the server to perform similarity computations and ranking in a vector space rather than performing simple keyword matching, which reduces retrieval time and increases accuracy. The prompt-construction module, which dynamically selects and compresses relevant parts of internal data, minimizes the size of data transmitted to the generative AI model and therefore reduces communication load and inference latency while maintaining sufficient context for high-quality outputs. The feedback-driven updating of evaluation values and ranking weights yields an adaptive system that improves its own precision and reduces misrecommendation rates over time, which is difficult for static rule-based systems.
   The explicit use of emotion-aware priority adjustment contributes to better utilization of computational resources and network resources. For example, by prioritizing experts who historically resolved issues quickly in situations where the user is frustrated and the failure is severe, the server reduces the number of subsequent recommendation cycles and messages. This leads to fewer network transactions and reduced server load, which is a technical improvement to the operation of the distributed system.
   The described neural-network models are not used merely to automate a human workflow but to implement computational transformations that a human could not feasibly perform in real time, such as high-dimensional similarity search across millions of records, attention-based integration of multi-source data, and continuous adaptation of ranking functions based on performance signals. The server uses non-conventional processing sequences, including building latent relationship graphs with embeddings, constructing custom prompt sentences conditioned on those embeddings, and applying feedback-driven score updates, which differ from generic data-retrieval pipelines. As a result, the server achieves improved expert identification precision, reduced time to locate suitable persons for equipment failures, and lower error rates in recommended response plans, thereby improving the functioning of the computer system itself. In alternative embodiments, the server may employ different neural-network architectures, such as recurrent networks or convolutional text encoders, instead of transformer-based models, while still performing the same type of integrated analysis and prompt construction. The server may also deploy different optimization methods, such as reinforcement-learning-based adjustment of prompt templates based on user satisfaction signals. The internal database schema may vary, for example including graph-structured stores for relationships between persons and equipment, as long as the processor is configured to combine structured records and model-generated embeddings into a unified internal representation. The generative AI model may be executed on a separate hardware accelerator node, in which case the server compresses and encrypts prompt sentences before network transmission and decompresses the received outputs, further reducing bandwidth and latency.
   In another embodiment, the server controls auxiliary devices such as mobile robots or wearable displays by embedding instructions derived from the generative AI model's response into control messages. For example, when a failure is detected, the server sends a control message to a mobile robot instructing it to approach a specific equipment location and display the recommended troubleshooting steps and expert contact information on a mounted display. This coupling between the analysis system and physical devices provides an additional technical effect in the real world, namely accelerated physical response and guided troubleshooting actions, beyond the abstract manipulation of data.
   Through these configurations and variations, the server, terminal, and associated components implement the claimed system in a manner that allows a person skilled in the art to realize the invention and that demonstrates concrete technical improvements in data processing efficiency, recommendation accuracy, failure-response latency, and adaptive system behavior.

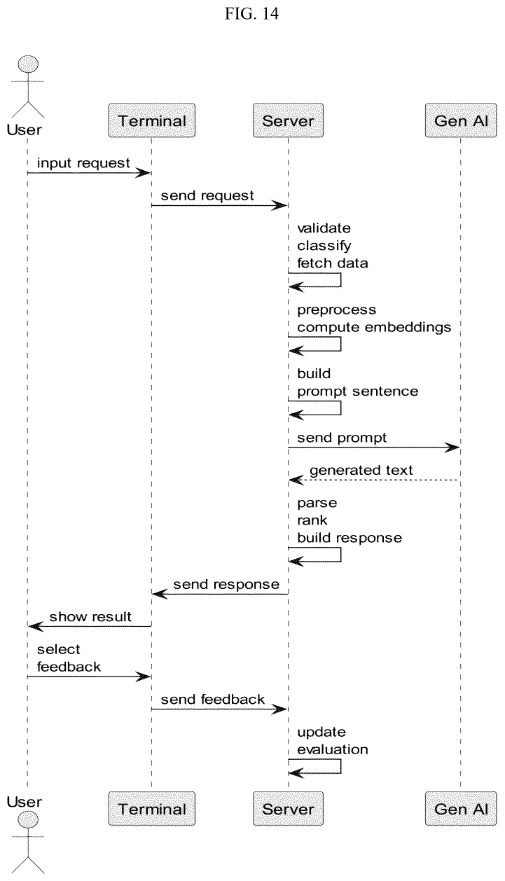

The following describes the processing flow using FIG. 14.

### Step 1:

User inputs a request.
User enters a natural language request into the terminal, such as “Find an engineer who can troubleshoot abnormal vibration on machine X” or “Find a person with more than 5 years of data-science experience.”
Input: free-form text entered by the user.
Terminal captures the text via a graphical input component and attaches metadata such as user identifier, time stamp, and request category (if selected by the user).
Terminal outputs a structured request message, for example a JSON object containing the text, user identifier, and metadata, and sends this message to the server over a network connection.

### Step 2:

Server receives and validates the request.
Server accepts the structured request message from the terminal via a network interface.
Input: structured request message including user text and metadata.
Server parses the message, verifies that mandatory fields are present (for example, non-empty text, valid user identifier), and rejects or logs invalid messages.
Server performs basic normalization on the text (lowercasing, normalization of whitespace, removal of control characters).
Server outputs a validated request record with a unique request identifier, and stores the record in an internal log table for later tracking.

### Step 3:

Server classifies the request type and selects relevant internal data.
Server takes the validated request text and applies a text classification routine, for example a lightweight neural classifier or rules, to categorize the request as expert search, equipment failure, task assignment, or general information query.
Input: validated request text and metadata.
Server uses the classification result to determine which internal tables to access, such as person tables for expert search, equipment and sensor tables for failures, or task tables for assignments.
Server issues database queries to retrieve records corresponding to the context, such as candidate persons, related equipment records, recent communication summaries, and outcome summaries.
Server outputs an in-memory context object that contains the request type, the request text, and the selected internal records to be used in later processing.

### Step 4:

Server preprocesses text and structured data.
Server reads the context object and applies text processing to communication data, outcome descriptions, and any textual attributes of persons and equipment.
Input: raw text fields and structured attributes from the internal records.
Server tokenizes the text into word or subword tokens, removes noise such as HTML tags and repetitive signatures, and performs part-of-speech tagging and sentence splitting.
Server applies named-entity recognition to extract entities such as skills, equipment names, locations, and error codes, and maps these entities to canonical identifiers stored in lookup tables.
Server outputs cleaned text segments, extracted entity lists, and normalized structured features, which together form an enriched context object.

### Step 5:

Server computes embeddings and relationship features using a large-scale language model.
Server feeds the cleaned text segments and extracted entities into the large-scale language model in batches.
Input: tokenized text sequences representing persons, equipment, communication, and outcomes.
Server passes the token sequences through the model's embedding layer, attention layers, and feed-forward layers to obtain contextual embeddings for each sequence.
Server aggregates token-level embeddings into sequence-level vectors (for example by averaging or using the first token representation) and treats these vectors as high-dimensional feature representations of persons, expertise, equipment states, and incidents.
Server outputs numerical embeddings and similarity scores that represent relationships between persons, areas of expertise, and equipment states, and attaches these to the enriched context object.

### Step 6:

Server analyzes or updates emotion information.
Server checks whether the terminal sent emotion-related data such as user self-reports, text segments, or pre-computed emotion labels.
Input: emotion-related text or labels associated with the request.
Server applies an emotion classifier to any new text, using features such as token embeddings and sentiment lexicon scores, to estimate an emotion label (for example, calm, frustrated, angry, or satisfied) and a confidence score.
Server may combine new labels with historical emotion records by smoothing or averaging to represent the current emotional state of the user.
Server outputs an updated emotion state record and updates the context object with the current emotion label and score.

### Step 7:

Server constructs a prompt sentence for the generative AI model.
Server reads the embeddings, internal records, and emotion state from the context object and selects salient information to include in a prompt sentence.
Input: request text, candidate person records, equipment state descriptions, historical incident summaries, and emotion state.
Server applies selection rules, for example choosing the top-k most similar historical incidents based on embedding similarity, or selecting the most relevant skills for each candidate person.
Server inserts these selected elements into a template to build a coherent text, for example:
“You are a diagnostic assistant. Analyze the following machine failure and required expertise. Machine state: [summarized sensor data and error codes]. Historical incidents: [summaries]. User request: ‘[original request text]’. Based on the above, list the required skills, relevant expertise domains, and criteria to choose the best expert.”
Server outputs the final prompt sentence string to be sent to the generative AI model.

### Step 8:

Server invokes the generative AI model and receives candidate outputs.
Server supplies the prompt sentence to the generative AI model via an inference interface.
Input: prompt sentence text produced in Step 7.
Server encodes the prompt into token identifiers, feeds them into the generative AI model, and runs inference to compute output token probabilities and select output tokens using a decoding strategy such as beam search or sampling with constraints.
Server decodes the generated tokens back into text, which may describe candidate persons, candidate workers, and candidate response plans, including reasons and conditions.
Server outputs one or more generated text segments representing the model's proposals and attaches them to the context object.

### Step 9:

Server parses and structures the generated text.
Server takes the generated text segments and applies parsing rules and pattern recognition to extract structured items.
Input: free-form generated text describing candidates and plans.
Server detects explicit markers such as “Candidate 1:”, skill labels, levels of experience, and suggested actions, and segments the text into records.
Server uses string matching and embedding similarity to map textual person descriptions to actual person identifiers and to map described actions to standardized action codes or templates.
Server outputs a structured candidate list and a structured response-plan list, each with associated attributes such as predicted relevance score and explanation fragments.

### Step 10:

Server ranks candidates and response plans using database information and evaluation values.
Server merges the structured candidate list with records from the internal database, including attribute information, operation history information, and performance information.
Input: structured candidate records from the generative AI model and corresponding internal database records.
Server computes a ranking score for each candidate by combining model confidence scores, years of experience, number of similar incidents handled, past success rate, and compatibility with the current emotion state according to predefined weighting coefficients.
Server may adjust the weights using previously stored evaluation values, for example increasing weight for effectiveness metrics that have correlated with successful outcomes.
Server outputs a ranked list of candidates and associated response plans, where each list item includes a person identifier, a ranking score, and a summary of reasoning.

### Step 11:

Server generates response information and transmits it to the terminal.
Server converts the ranked lists and reasoning into user-oriented response information.
Input: ranked candidates and plans with structured attributes.
Server composes explanatory text, such as “Top recommended expert: [name], because of [reasons],” and selects a subset of the most relevant candidates and actions to avoid overloading the user.
Server packages the contact information, recommendation scores, and explanatory text into a response message structure suitable for the terminal.
Server outputs the response message and sends it to the terminal over the network.

### Step 12:

Terminal displays the response and supports user actions.
Terminal receives the response message from the server and parses its structured content.
Input: response message containing candidate lists, response plans, and explanations.
Terminal renders the information on the display as lists or cards, showing names, departments, skills, and contact controls (for example, buttons to start an e-mail or chat).
Terminal may highlight candidates or plans with higher priority using visual cues and may provide controls for the user to provide feedback, such as “useful” or “not useful.”
Terminal outputs user interactions, such as chosen candidate or feedback signals, back to the server for logging and future learning.

### Step 13:

User selects recommended options and optionally provides feedback.
User inspects the displayed candidates and response plans on the terminal.
Input: visual presentation of recommendations and explanations.
User selects one or more recommended persons or plans, initiates contact through the terminal if necessary, and may provide explicit feedback on the usefulness or correctness of the recommendation.
User's selections and feedback form implicit and explicit performance signals that can be sent back to the server.
User's actions do not directly compute new data but induce new records that will be processed by the server in subsequent operations.

### Step 14:

Server updates evaluation values and internal models based on outcomes.
Server receives feedback and outcome information, such as whether the selected recommendation resolved the issue, and in what time frame.
Input: feedback signals, resolution status, and timing information associated with the request identifier.
Server updates evaluation values for the involved candidates and response plans by adjusting their performance metrics, for example increasing a success score when an issue is resolved quickly or decreasing it when a recommendation leads to poor results.
Server may periodically use these updated evaluation values to retrain or fine-tune ranking parameters or auxiliary models used in request classification and prompt construction.
Server outputs updated evaluation records and refined model parameters, which will influence data processing and recommendation quality in future requests.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

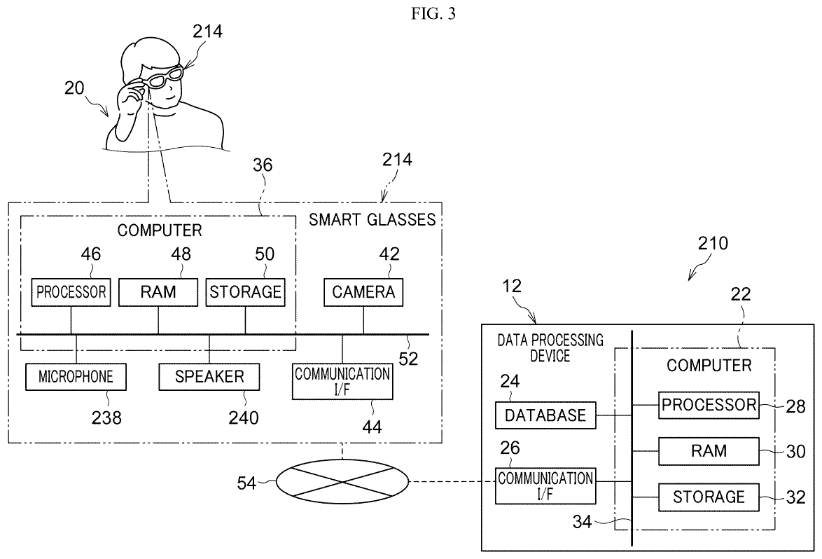

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

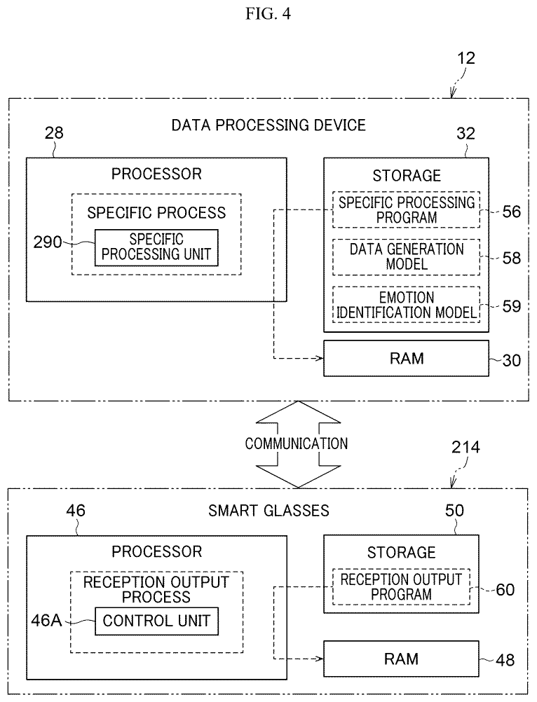

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

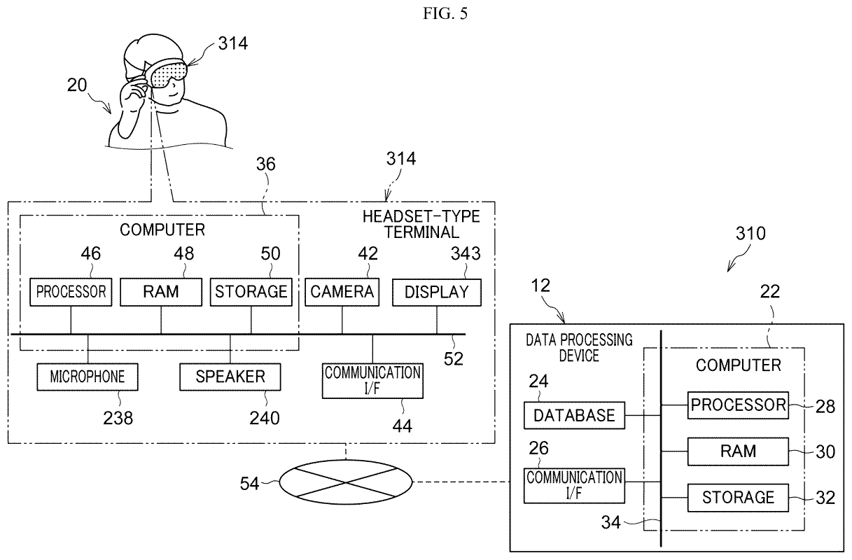

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

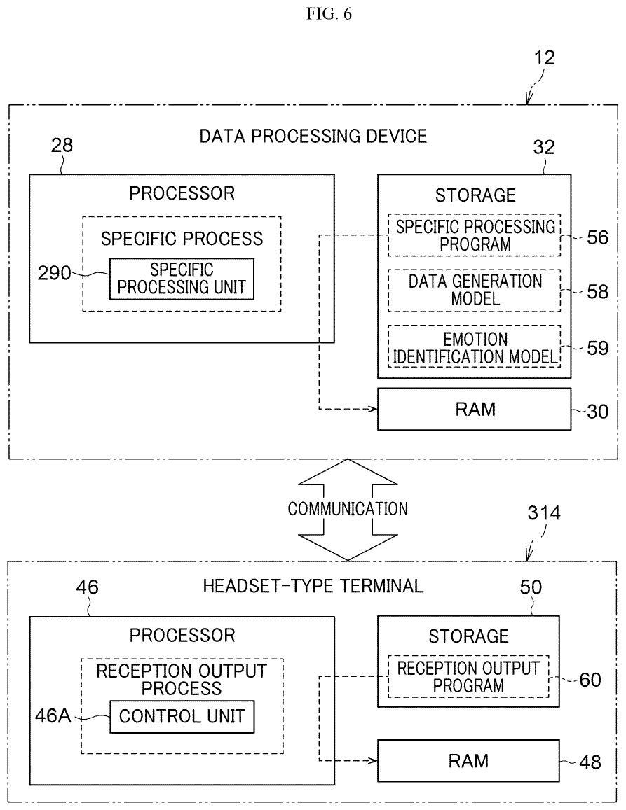

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

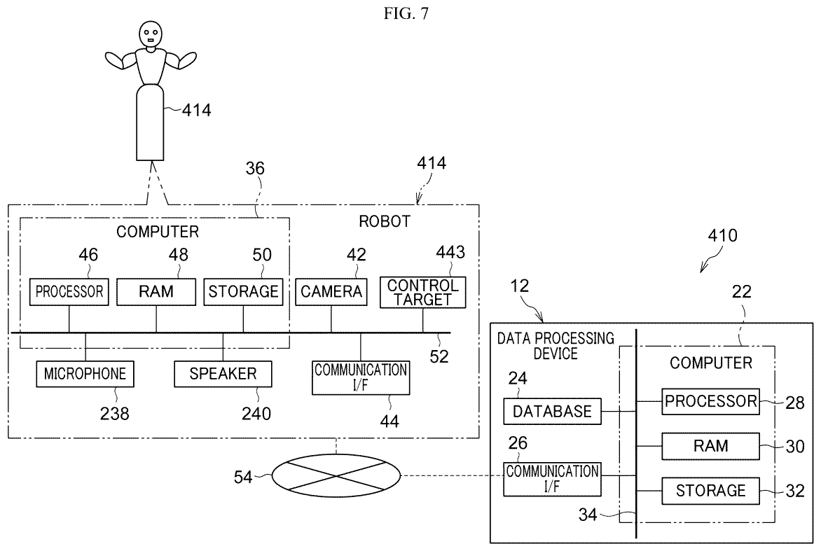

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

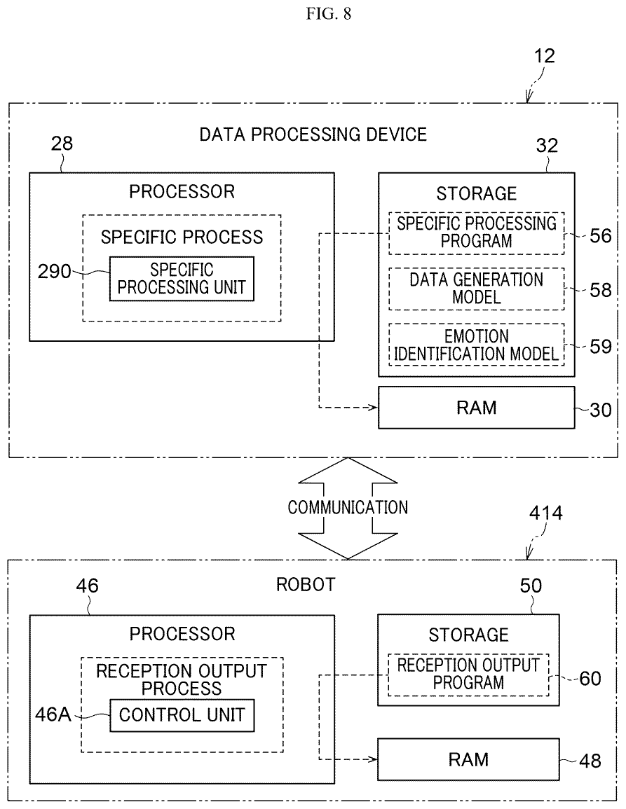

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

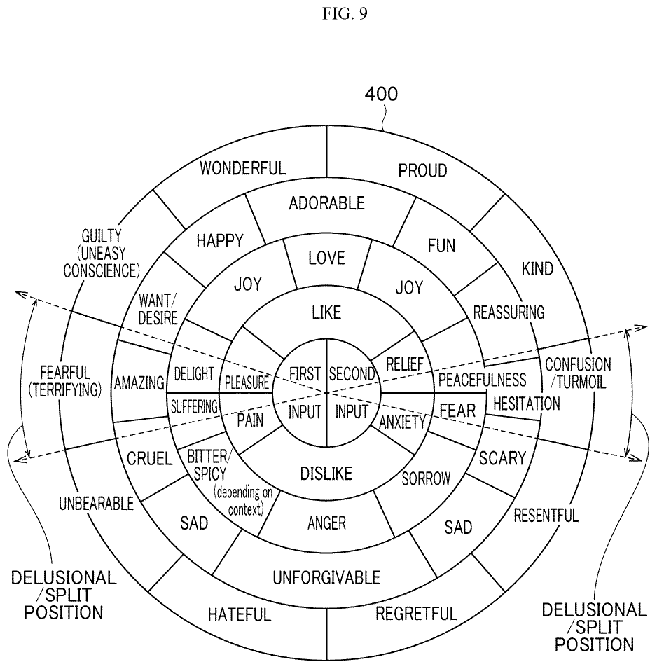

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

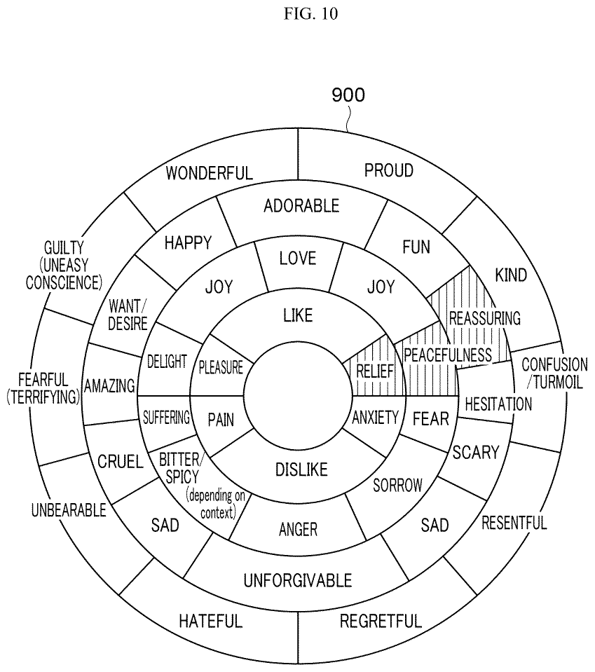

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from a plurality of information sources, attribute information, communication history information, and deliverable information regarding persons, integrate the acquired information, and store the integrated information as recorded information,
extract character data from the recorded information, normalize an encoding format, a notation format, and a layout of the character data, remove unnecessary portions from the character data, and generate analysis target data to be input to a large-scale language model,
divide the analysis target data into units, generate analysis data sets grouped on a person basis or a topic basis while controlling a token count or a character count in accordance with an input constraint of the large-scale language model,
input the analysis data sets into the large-scale language model, obtain analysis results including expertise information of the persons and relationship information between the persons from the large-scale language model, and store the analysis results as structured data,
generate a relationship structure indicating correspondences among the persons, skills, and relationships on the basis of the structured data, and hold the relationship structure as a searchable knowledge representation,
receive a prompt sentence in a natural language input by a user, cause a generative AI model to generate an intermediate representation for converting the prompt sentence into a structured query including a search condition for the relationship structure, and perform a search process on the relationship structure on the basis of the intermediate representation obtained from the generative AI model, and
generate a prompt sentence to input response data including the structured data obtained as a result of the search process into the generative AI model, and obtain an answer sentence in the natural language from the generative AI model.

### (Supplementary 2)

The system according to supplementary 1,
wherein the processor is configured to
in generating the prompt sentence and the intermediate representation, instruct the generative AI model to limit candidates of the persons, the skills, and the relationships between the persons to those satisfying conditions designated by the prompt sentence input by the user, and to generate the answer sentence using only identifiers and attributes included in the structured data, and verify whether content output from the generative AI model corresponds to information included in the structured data, thereby performing processing to improve reliability of the answer sentence.

### (Supplementary 3)

The system according to supplementary 1,
wherein the processor is configured to
use the relationship structure to extract a set of persons satisfying predetermined skill conditions or project conditions on the basis of skill information, project information, and collaboration history information included in the analysis results, and generate a prompt sentence to input attribute information of the extracted set of persons into the generative AI model, thereby specifying persons who have particular expertise and satisfy predetermined collaboration conditions.

### Application Example 1

### (Supplementary 1)

A system comprising a processor,
wherein the processor is configured to
acquire information including attribute information related to personnel, communication history information, and deliverable information from an information storage device or an external information providing device, and integrate the information and perform preprocessing to generate structured data, and
generate a prompt sentence for inputting the structured data to a large language model, input the structured data to the large language model by using the prompt sentence, and analyze the structured data by using the large language model to generate analysis result data identifying relationships between personnel and specialty fields or strengths of individual personnel, and
generate team composition information including combinations of a plurality of personnel and roles of the respective personnel for a project, based on the analysis result data and requirement information related to the project, and
transmit the team composition information to a terminal device, acquire correction instruction information or approval instruction information from a user via the terminal device, and update or finalize the team composition information based on the correction instruction information or the approval instruction information, and
record the prompt sentence and response content from the large language model as log data, and adjust generation conditions of the prompt sentence or generation conditions of the team composition information based on the log data.

### (Supplementary 2)

The system according to supplementary 1,
wherein the processor is configured to
select personnel so as to satisfy project requirements including necessary skills, a number of roles, personnel constraints, and work conditions, based on collaboration relationship information and specialty field information between personnel included in the analysis result data, generate a plurality of patterns of the team composition information, and add selection reason information to each piece of the team composition information.

### (Supplementary 3)

The system according to supplementary 1,
wherein the processor is configured to
generate the prompt sentence by using project requirement information input by the user and analysis target information including the structured data, the prompt sentence including an instruction for a generative AI model to extract strengths, weaknesses, role suitability, and relationships between personnel, and an instruction for the generative AI model to output the team composition information in a predetermined data format based on an extraction result, and input the prompt sentence to the generative AI model.

### Example 2

### (Supplementary 1)

A system comprising a processor,
wherein the processor is configured to
acquire component information relating to an organization from a storage device and from a business management device, the component information including data representing attribute information, skill information, and work history information, and to collect and integrate the data as the component information,
perform preprocessing including natural language processing on the component information and on problem description information obtained from a user, generate summary information of the component information, and calculate a relevance between the problem description information and the summary information,
construct a prompt sentence, based on the problem description information and the summary information, for instructing a generative AI model to select internal components, input the prompt sentence to the generative AI model, and obtain analysis result information including an identifier of a component and relevance information,
acquire detailed attribute information of the component from the storage device based on the identifier of the component included in the analysis result information, and rank the components based on the relevance information, and
generate recommendation information including the identifier, the attribute information, and expertise information of the ranked components, and transmit the recommendation information to a user terminal for display.

### (Supplementary 2)

The system according to supplementary 1,
wherein the processor is configured to
receive selection information indicating a component selected by a user based on the recommendation information, store the selection information as record information, and adjust at least one of the prompt sentence and the preprocessing based on the record information so as to improve a subsequent recommendation process for components.

### (Supplementary 3)

The system according to supplementary 1,
wherein the processor is configured to
estimate a technical field or an area of expertise corresponding to the problem description information based on the analysis result information, and specify a component matching the technical field or the area of expertise and include the component in the recommendation information.

### Application Example 2

### (Supplementary 1)

A system comprising a processor,
wherein the processor is configured to
collect and preprocess information and generate integrated internal data including information regarding capabilities of human resources, information regarding equipment, information regarding communication, information regarding outcomes, and information regarding emotions, analyze, on the basis of the internal data, relationships between persons and areas of expertise, and states and failure contents of equipment, by using a large-scale language model, automatically generate a prompt sentence to be input to a generative AI model on the basis of the large-scale language model used for the analysis and on the basis of an analysis result, input the prompt sentence to the generative AI model, and cause the generative AI model to output at least one of a candidate person, a candidate worker, and a candidate response plan,
collate at least one of the candidate person, the candidate worker, and the candidate response plan with attribute information of persons and operation history information stored in an internal database, select a person having at least one of a specific area of expertise and a specific capability, and generate result information including contact information regarding the person and a reason for recommendation,
adjust a priority of at least one of the selected person and the response plan in accordance with an inquiry content input by a user and the information regarding emotions, and generate response information including a recommendation result according to an emotional state, and
transmit the response information to a terminal device and provide the response information as output data for display.

### (Supplementary 2)

The system according to supplementary 1,
wherein the processor is configured to update an evaluation value of at least one of the candidate person and the candidate response plan by using an output acquired from the generative AI model and performance information stored in the internal database, and dynamically change, on the basis of the updated evaluation value, a content of generation of the prompt sentence and a recommendation result in future processing.

### (Supplementary 3)

The system according to supplementary 1,
wherein the processor is configured to detect an event regarding equipment failure on the basis of sensor data or abnormality notification acquired from the equipment, use the large-scale language model and the generative AI model in response to occurrence of the event to estimate a cause of the failure and a required capability, specify a person having at least one of a specific area of expertise and a specific capability on the basis of the estimation, and transmit notification information to a terminal device of the specified person.

What is claimed is:

1. A system comprising:
circuitry configured to
receive, via a packet-switched network, a plurality of heterogeneous data records from a plurality of data source interfaces;
normalize encoding format data, notation format data, and structural layout data of character sequences extracted from the plurality of heterogeneous data records to generate normalized analysis data;
segment the normalized analysis data into token-bounded data units conforming to an input constraint of a transformer-based language model, and input the token-bounded data units into the transformer-based language model to generate structured inference output data comprising classification label data and association data;
generate, based on the structured inference output data, a graph data structure comprising entity nodes and association edges representing correspondences identified by the transformer-based language model;
receive, via the packet-switched network, an input character sequence from a terminal device, generate a structured input sequence for a generative neural network model based on the input character sequence and the graph data structure, and input the structured input sequence into the generative neural network model to obtain an intermediate representation encoding a structured query for the graph data structure;
execute a search operation on the graph data structure based on the intermediate representation to retrieve response data; and
generate a second structured input sequence comprising the response data and the input character sequence, input the second structured input sequence into the generative neural network model to generate output character sequence data, and transmit the output character sequence data via the packet-switched network to the terminal device for rendering on a display of the terminal device.

2. The system according to claim 1, wherein normalizing the encoding format data comprises converting the character sequences to a uniform character encoding, standardizing date format representations and numerical format representations, and removing boilerplate character patterns identified by pattern matching rules.

3. The system according to claim 2, wherein segmenting the normalized analysis data comprises applying a tokenization function corresponding to a vocabulary of the transformer-based language model, computing a token count for each candidate data segment, and merging or splitting data segments such that each token-bounded data unit satisfies a maximum token count threshold.

4. The system according to claim 3, wherein the plurality of heterogeneous data records comprise attribute data records, communication history data records, and deliverable data records associated with entity identifiers, and wherein the token-bounded data units are grouped on an entity basis such that data records associated with a common entity identifier are processed together.

5. The system according to claim 4, wherein the entity identifiers correspond to persons in an organization, the classification label data comprises expertise field labels and skill proficiency indicators, and the association data comprises collaboration relationship indicators between pairs of persons, and wherein the graph data structure represents a knowledge graph of organizational expertise and inter-personnel relationships.

6. The system according to claim 1, wherein the transformer-based language model comprises an embedding layer, a plurality of self-attention layers each comprising multi-head attention operations, feed-forward layers with non-linear activation functions, and layer normalization, and wherein generating the structured inference output data comprises performing forward propagation through the plurality of self-attention layers to produce contextualized token embedding vectors.

7. The system according to claim 6, wherein the circuitry is further configured to apply classifier head modules to the contextualized token embedding vectors to derive classification labels and confidence score values, and to store the classification labels and confidence score values as the structured inference output data in a persistent storage device.

8. The system according to claim 7, wherein generating the graph data structure comprises creating entity nodes associated with normalized entity identifiers and classification labels, creating association edges linking pairs of entity nodes based on the association data, assigning confidence score values to the association edges, and building index structures over node properties and edge types to accelerate search operations.

9. The system according to claim 1, wherein generating the structured input sequence for the generative neural network model comprises concatenating a schema description of entity types and association types available in the graph data structure with the input character sequence received from the terminal device.

10. The system according to claim 9, wherein the intermediate representation comprises a key-value data structure specifying a target entity type, at least one association type constraint, and at least one classification label constraint, and wherein the circuitry is further configured to validate the intermediate representation by confirming that referenced field identifiers correspond to schema elements of the graph data structure.

11. The system according to claim 10, wherein executing the search operation comprises translating the intermediate representation into a graph traversal query, traversing entity nodes and association edges of the graph data structure according to the graph traversal query, and retrieving matching entity records and associated attribute data as the response data.

12. The system according to claim 11, wherein the circuitry is further configured to verify the output character sequence data by parsing the output character sequence data to detect entity identifiers and confirming that each detected entity identifier is present in the response data, and upon detecting an entity identifier absent from the response data, regenerating the output character sequence data with adjusted constraint parameters in the second structured input sequence.

13. The system according to claim 1, wherein the second structured input sequence comprises an instruction segment directing the generative neural network model to reference only entity identifiers and attribute values present in the response data when generating the output character sequence data.

14. The system according to claim 13, wherein the circuitry is further configured to record the structured input sequence, the second structured input sequence, and the output character sequence data as log data in a storage device, and to adjust generation parameters for constructing future structured input sequences based on statistical analysis of the log data.

15. The system according to claim 1, wherein the circuitry is further configured to receive, via the packet-switched network, requirement parameter data from the terminal device, and to generate combination data representing groupings of entity identifiers satisfying constraints specified in the requirement parameter data based on the structured inference output data.

16. The system according to claim 15, wherein generating the combination data comprises computing an objective function value for each candidate grouping based on classification label coverage, association strength values between entity identifiers, and workload balance parameters, and selecting groupings that maximize the objective function value while satisfying the constraints.

17. The system according to claim 16, wherein the requirement parameter data comprises project skill requirements, role specifications, and personnel count constraints, and wherein the combination data represents team composition proposals assigning persons to roles for a project, and the circuitry is further configured to transmit the team composition proposals to the terminal device and to receive correction or approval instruction data from the terminal device via the packet-switched network.

18. A system comprising:
circuitry configured to
receive, via a packet-switched network, a plurality of heterogeneous data records from a plurality of data source interfaces and an input character sequence from a terminal device;
extract character sequences from the plurality of heterogeneous data records, normalize encoding format data and notation format data of the character sequences, segment the normalized character sequences into token-bounded data units conforming to an input constraint of a transformer-based language model, and input the token-bounded data units into the transformer-based language model to generate structured inference output data;
generate a graph data structure comprising entity nodes and association edges based on the structured inference output data, and build index structures over properties of the entity nodes and association edges;
concatenate a schema description of the graph data structure with the input character sequence to form a first structured input sequence, input the first structured input sequence into a generative neural network model to obtain an intermediate representation encoding a structured query, validate the intermediate representation against the schema description, and execute a search operation on the graph data structure based on the validated intermediate representation to retrieve response data;
generate a second structured input sequence comprising the response data and the input character sequence with an instruction to reference only identifiers present in the response data, input the second structured input sequence into the generative neural network model to generate output character sequence data, and verify the output character sequence data against the response data; and
transmit the verified output character sequence data via the packet-switched network to the terminal device for rendering on a display of the terminal device.

19. The system according to claim 18, wherein the circuitry is further configured to record the first structured input sequence, the second structured input sequence, and the output character sequence data as log data, and to adjust generation parameters for constructing future structured input sequences based on correlation analysis between the log data and acceptance indicators received from the terminal device.

20. A method performed by a system comprising circuitry, the method comprising:
receiving, via a packet-switched network, a plurality of heterogeneous data records from a plurality of data source interfaces;
normalizing encoding format data, notation format data, and structural layout data of character sequences extracted from the plurality of heterogeneous data records to generate normalized analysis data;
segmenting the normalized analysis data into token-bounded data units conforming to an input constraint of a transformer-based language model, and inputting the token-bounded data units into the transformer-based language model to generate structured inference output data comprising classification label data and association data;
generating, based on the structured inference output data, a graph data structure comprising entity nodes and association edges representing correspondences identified by the transformer-based language model;
receiving, via the packet-switched network, an input character sequence from a terminal device, generating a structured input sequence for a generative neural network model based on the input character sequence and the graph data structure, and inputting the structured input sequence into the generative neural network model to obtain an intermediate representation encoding a structured query for the graph data structure;
executing a search operation on the graph data structure based on the intermediate representation to retrieve response data; and
generating a second structured input sequence comprising the response data and the input character sequence, inputting the second structured input sequence into the generative neural network model to generate output character sequence data, and transmitting the output character sequence data via the packet-switched network to the terminal device for rendering on a display of the terminal device.
